(19) United States
(12) Patent Application Publication
(10) Pub. No.: US 2026/0116069 A1
(43) Pub. Date: Apr. 30, 2026

(54) LIQUID EJECTION HEAD AND LIQUID EJECTION APPARATUS

(71) Applicant: CANON KABUSHIKI KAISHA, Tokyo (JP)

(72) Inventors: KYOSUKE TODA, Kanagawa (JP); YASUAKI KITAYAMA, Kanagawa (JP); SATOSHI IDETA, Kanagawa (JP)

(21) Appl. No.: 19/367,382

(22) Filed: Oct. 23, 2025

(30) Foreign Application Priority Data
Oct. 24, 2024 (JP) 2024-187423

(51) Int. Cl. B41J 2/14; B41J 3/54; B41J 11/00

(52) U.S. Cl. CPC B41J 2/14145; B41J 3/543; B41J 11/0015

(57) ABSTRACT

Provided is a liquid ejection head including: an ejection element substrate having a plurality of ejection port arrays each being a plurality of ejection ports for ejecting a liquid arranged in a line; and a first channel member and a second channel member forming a plurality of liquid channels communicating the plurality of ejection port arrays. The first channel member or the second channel member supports the ejection element substrate. The first channel member is formed using a resin material, is joined to the second channel member, and has a beam portion dividing part of the liquid channels into a plurality of parallel channels. The beam portions in adjacent liquid channels among the plurality of liquid channels are arranged to be offset from each other.

### BACKGROUND

### Field of the Technology

The present disclosure relates to a liquid ejection head and a liquid ejection apparatus.

### DESCRIPTION OF THE RELATED ART

As liquid ejection apparatuses, there are inkjet printers that perform printing by ejecting liquids, such as inks, from liquid ejection heads. In recent years, the applications of liquid ejection apparatuses have been expanding beyond printing. For example, liquid ejection apparatuses are expected to be applied to the forming of electrodes, the manufacturing of biochips, and so on. Thus, there has been a demand for liquid ejection heads and liquid ejection apparatuses that are capable of stably ejecting not only inks containing color materials but also functional inks containing various materials. In the field of printing too, there has been a demand for long-life, highly reliable liquid ejection heads that are compatible with a wide variety of inks and media. Also, there is a demand for low‑cost, highly productive liquid ejection heads that can support high print speeds.

Japanese Patent Laid-Open No 2016-221692 discloses a liquid ejection head including ejection element substrates for ejecting liquids. The ejection element substrates have relatively long ejection port arrays for handling high print speeds. The liquid ejection head is provided with elongated liquid channels capable of supplying the liquids uniformly in large amounts to the ejection port arrays in the ejection element substrates. In the liquid channels, beam portions (beam-shaped members) for preventing deformation of the liquid channels are provided.

### SUMMARY

An object of the present disclosure is to provide a liquid ejection head with high reliability.

A liquid ejection head according to an aspect of the present disclosure includes: an ejection element substrate having a plurality of ejection port arrays each being a plurality of ejection ports for ejecting a liquid arranged in a line; and a first channel member and a second channel member forming a plurality of liquid channels communicating the plurality of ejection port arrays. The first channel member or the second channel member supports the ejection element substrate. The first channel member is formed using a resin material, is joined to the second channel member, and has a beam portion dividing part of the liquid channels into a plurality of parallel channels. The beam portions in adjacent liquid channels among the plurality of liquid channels are arranged to be offset from each other.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view schematically illustrating a liquid ejection apparatus;

FIG. 2 is a perspective view of a first liquid ejection head;

FIG. 3 is an exploded perspective view of the first liquid ejection head;

FIG. 4 is a schematic diagram illustrating a circulation path for an ink in a steady state;

FIG. 5 is a perspective view illustrating a cross section of an ejection element substrate;

FIG. 6 is a schematic diagram illustrating the inside of a circulation unit;

FIG. 7 is a side view of the first liquid ejection head;

FIGS. 8A and 8B are cross-sectional views of the first liquid ejection head;

FIGS. 9A and 9B are side cross-sectional views of the first liquid ejection head;

FIGS. 10A and 10B are horizontal cross-sectional views of the first liquid ejection head;

FIGS. 11A and 11B are horizontal cross-sectional views of a second liquid ejection head;

FIG. 12 is a schematic diagram illustrating ink supply paths;

FIG. 13 is a perspective view illustrating a cross section of an ejection element substrate;

FIG. 14 is a partial cross-sectional view of a second liquid ejection head;

FIGS. 15A and 15B are side cross-sectional views of the second liquid ejection head;

FIGS. 16A and 16B are horizontal cross-sectional views of the second liquid ejection head;

FIGS. 17A and 17B are horizontal cross-sectional views of a second liquid ejection head; and

FIGS. 18A and 18B are schematic diagrams illustrating the orientations of fillers.

### DESCRIPTION OF THE EMBODIMENTS

Preferred embodiments of the present disclosure will be specifically described below with reference to the accompanying drawings. Note that the following embodiments do not limit the contents of the present disclosure, and not all of the combinations of the features described in the following embodiments are necessarily essential for the solution to be provided by the present disclosure. Note that identical components will be described with the same reference sign.

### First Embodiment

A liquid ejection head and liquid ejection apparatus according to a first embodiment are applicable to various types of apparatuses such as printers, copiers, facsimiles having a communication system, and word processors having a printer unit. The liquid ejection head and the liquid ejection apparatus are applicable to industrial apparatuses combining various types of processing apparatuses. Also, the liquid ejection head and the liquid ejection apparatus are usable, for example, in manufacturing of biochips, printing of electronic circuits, and printing on non-absorbent media, and so on. Note that a liquid ejection head with beam portions provided in liquid channels has a possibility that stress concentration at the beam portions may break the beam portions, thus lowering the reliability of the liquid ejection head. In the first embodiment, a liquid ejection head and liquid ejection apparatus with high reliability will be described.

### Configuration of Liquid Ejection Apparatus

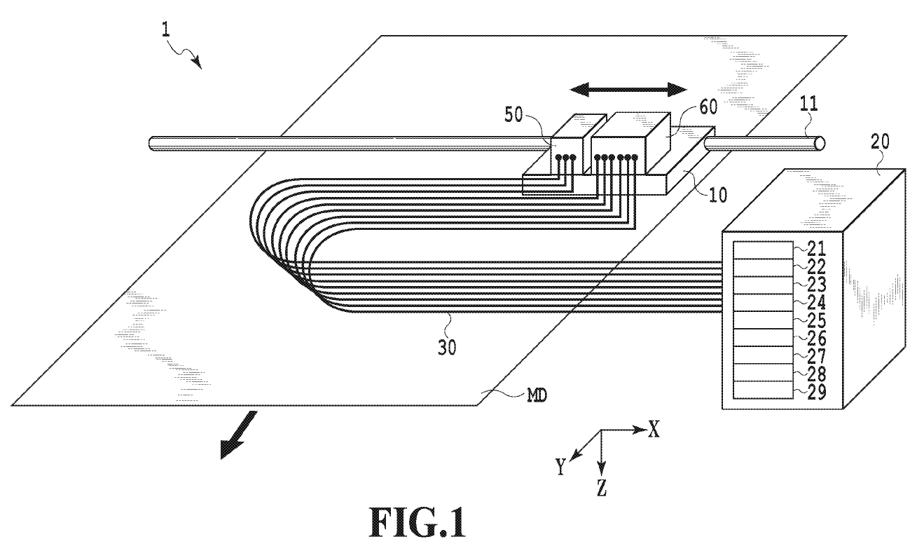

FIG. 1 is a perspective view schematically illustrating a liquid ejection apparatus 1. As illustrated in FIG. 1, the liquid ejection apparatus 1 in the present embodiment includes a carriage 10, a supply unit 20, supply tubes 30, a first liquid ejection head 50, and a second liquid ejection head 60. The liquid ejection apparatus 1 prints an image on a print medium MD by ejecting liquids, such as inks, from the first liquid ejection head 50 and the second liquid ejection head 60. The carriage 10 carries the first liquid ejection head 50 and the second liquid ejection head 60. The carriage 10 reciprocally moves in a main scanning direction (X direction) along a guide shaft 11. The print medium MD is conveyed by conveyance rollers not illustrated in a sub scanning direction (Y direction) crossing (in the present embodiment, orthogonally crossing) the main scanning direction. The liquid ejection apparatus 1 is configured as a serial inkjet printing apparatus which performs printing on the print medium MD by causing the first liquid ejection head 50 and the second liquid ejection head 60 to eject the inks while moving them in the main scanning direction. Note that, in drawings to be referred to below, the Z direction represents a vertical direction and crosses (in this example, orthogonally crosses) an X-Y plane defined by the X direction and the Y direction.

The first liquid ejection head 50 and the second liquid ejection head 60 are arranged side by side in the main scanning direction (X direction) and fixed to an upper portion of the carriage 10 by a positioning mechanism and electric contacts provided to the carriage 10. The first liquid ejection head 50 is capable of ejecting three types of ink, and the second liquid ejection head 60 is capable of ejecting six types of ink. Nine types of storage tanks 21 to 29 of the supply unit 20 are connected to the first liquid ejection head 50 and the second liquid ejection head 60 through the supply tubes 30.

For example, a first storage tank 21, a second storage tank 22, and a third storage tank 23 are connected to the first liquid ejection head 50. A fourth storage tank 24, a fifth storage tank 25, a sixth storage tank 26, a seventh storage tank 27, an eighth storage tank 28, and a ninth storage tank 29 are connected to the second liquid ejection head 60. The first to third storage tanks 21 to 23 store three types of ink to be ejected from the first liquid ejection head 50. The fourth to ninth storage tanks 24 to 29 store six types of ink to be ejected from the second liquid ejection head 60. Note that the ratio of the solvent contained in each ink is 20% or more and 25% or less, for example. The ratio of the solvent contained in each of the liquids (inks) to be ejected from the first liquid ejection head 50 or the second liquid ejection head 60 is desirably 5% or more. The ratio of the solvent contained in each of the liquids to be ejected from the first liquid ejection head 50 or the second liquid ejection head 60 may be 100% or less or 80% or less.

Also, the supply unit 20 is equipped with supply pumps for pressurizing and supplying the inks stored in the nine types of storage tanks 21 to 29 to the first liquid ejection head 50 and the second liquid ejection head 60. The inks stored in the first to third storage tanks 21 to 23 are supplied under pressure to the first liquid ejection head 50 through the corresponding supply tubes 30 by the corresponding supply pumps of the supply unit 20. The inks stored in the fourth to ninth storage tanks 24 to 29 are supplied under pressure to the second liquid ejection head 60 through the corresponding supply tubes 30 by the corresponding supply pumps of the supply unit 20.

Incidentally, the first liquid ejection head 50 may be configured to eject one type of ink, so that seven types of storage tanks are connected to the first liquid ejection head 50 and the second liquid ejection head 60. The first liquid ejection head 50 may be configured to eject two types of ink, so that eight types of storage tanks are connected to the first liquid ejection head 50 and the second liquid ejection head 60. Also, a third liquid ejection head (not illustrated) capable of ejecting at least three types of ink may be mounted on the carriage 10, so that 12 or more types of storage tanks are connected to the first to third liquid ejection head. For example, a third liquid ejection head configured similarly to the first liquid ejection head 50 may be mounted on the carriage 10, so that 12 types of storage tanks are connected to the first to third liquid ejection heads. A third liquid ejection head configured similarly to the second liquid ejection head 60 may be mounted on the carriage 10, so that 15 types of storage tanks are connected to the first to third liquid ejection heads.

Also, the first liquid ejection head 50 may be capable of ejecting a reaction liquid that reacts with the inks ejected from the second liquid ejection head 60. In this case, the first liquid ejection head 50 may be configured to eject one type of reaction liquid, so that seven types of storage tanks are connected to the first liquid ejection head 50 and the second liquid ejection head 60. Also, in the case where a third liquid ejection head is mounted on the carriage 10, the first liquid ejection head 50 may be capable of ejecting three types of reaction liquid that react with three types of ink among the six types of ink ejected from the second liquid ejection head 60. The third liquid ejection head may be configured similarly to the first liquid ejection head 50 and capable of ejecting three types of reaction liquid that react with the other three types of ink among the six types of ink ejected from the second liquid ejection head 60. In this case, 12 types of storage tanks may be connected to the first to third liquid ejection heads. As described above, some of the multiple liquid ejection heads may be capable of ejecting reaction liquids that react with the liquids ejected from the other liquid ejection heads excluding the some liquid ejection head or heads.

Also, the inks may be aqueous inks containing color materials dispersed by the actions of anionic groups. The reaction liquid may be an aqueous reaction liquid containing a water-soluble cationic resin having a quaternary ammonium salt structure and a polyvalent metal salt. The reaction liquid reacts with each ink upon contact with the ink, causing coagulation of components in the ink (resins, a surfactant, and components having anionic groups, such as a self-dispersing pigments). As a reactant, it contains a specific water-soluble cationic resin and a polyvalent metal salt.

### Configuration of Liquid Ejection Head

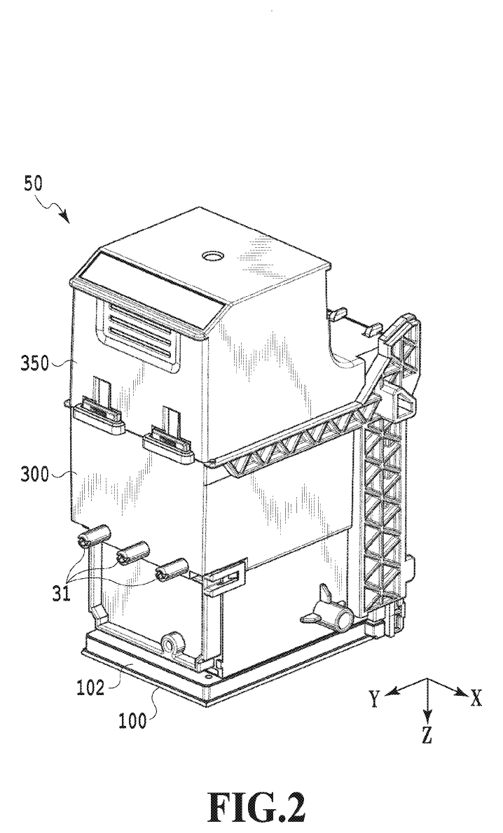

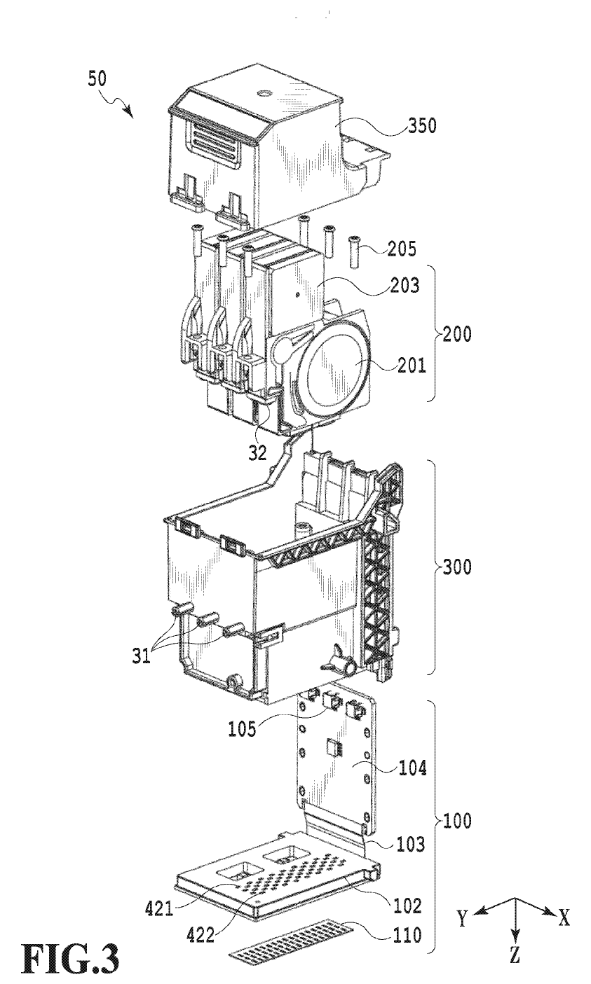

Next, the first liquid ejection head 50 in the first embodiment will be described. FIG. 2 is a perspective view of the first liquid ejection head 50. FIG. 3 is an exploded perspective view of the first liquid ejection head 50. As illustrated in FIGS. 2 and 3, the first liquid ejection head 50 an ejection element unit 100, circulation units 200, a head housing unit 300, and a cover 350.

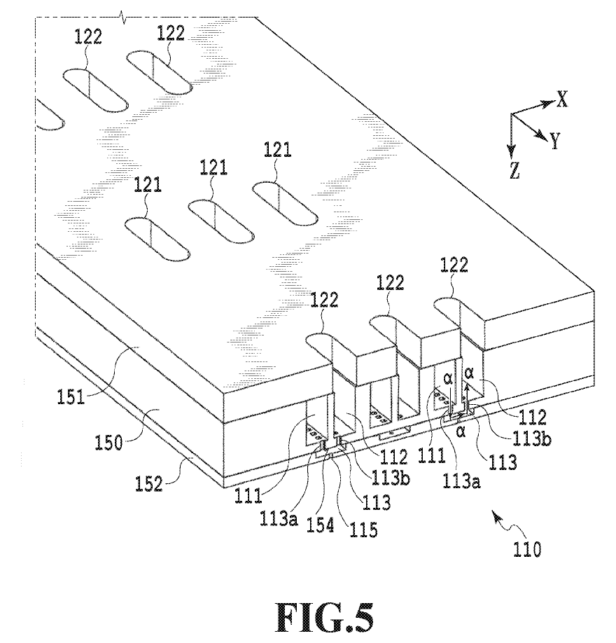

As illustrated in FIG. 3, the ejection element unit 100 includes an ejection element substrate 110, a support member 102, electric wiring tape 103, and an electric contact substrate 104. In the ejection element substrate 110, ejection port arrays are formed each of which is multiple ejection ports 115 (see FIG. 5) for ejecting an ink arranged in a line. Details of the ejection element substrate 110 will be described later.

The support member 102 supports the ejection element substrate 110 and is adhesively fixed to a lower portion of the head housing unit 300. The support member 102 supports the ejection element substrate 110 in a state where it is joined to the ejection element substrate 110. The support member 102 is formed in a plate shape using alumina, for example. The thermal conductivity of alumina is high, and the coefficient of linear expansion of alumina is low. This makes it possible to reduce the stress to be generated in the ejection element substrate 110 supported by the support member 102 and make the internal temperature of the ejection element substrate 110 uniform. In the support member 102, supply-side connection channels 421 and collection-side connection channels 422 are formed which communicate with the ejection ports 115 in the ejection element substrate 110.

The electric wiring tape 103 is electrically connected to the ejection element substrate 110 and the electric contact substrate 104. The electric contact substrate 104 has electric contacts with the carriage 10. The electric contact substrate 104 sends drive signals and electric energy for ink circulation to circulation pumps 203 of the circulation units 200 through circulation unit connectors 105 and pump wirings (not illustrated). Also, the electric contact substrate 104 sends drive signals and electric energy for ink ejection to the ejection element substrate 110 through the electric wiring tape 103.

Usable methods to electrically connect components include, but are not limited to, using an anisotropic conductive film (not illustrated), wire bonding, and soldering. In the present embodiment, the ejection element substrate 110 and the electric wiring tape 103 are electrically connected using wire bonding. The electrically connecting portions of the ejection element substrate 110 and the electric wiring tape 103 are sealed with a sealant (not illustrated) to be protected from corrosion by the inks and external impacts.

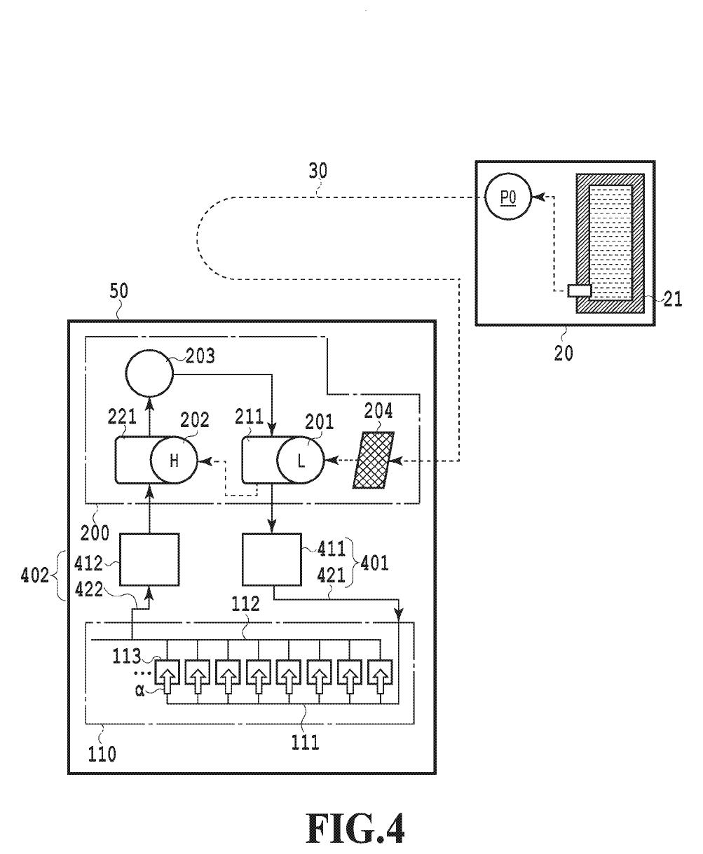

Each circulation unit 200 includes a liquid supply port 32, a first pressure adjustment mechanism 201, a second pressure adjustment mechanism 202(see FIG. 4), and a circulation pump 203. There are provided three circulation units 200 (three liquid supply ports 32, first pressure adjustment mechanisms 201, second pressure adjustment mechanisms 202, and circulation pumps 203) for the three types of ink. The liquid supply ports 32 are connected to tube connecting portions 31 inside the head housing unit 300. The tube connecting portions 31 are formed on the side of the head housing unit 300 in the +Y direction and connected to the corresponding supply tubes 30. Each liquid supply port 32 is supplied with the ink stored in the corresponding one of the first to third storage tanks 21 to 23 through the corresponding supply tube 30 and tube connecting portion 31.

The head housing unit 300 is formed in a box shape capable of accommodating the three circulation units 200 by using a resin material to which a filler is added. The filler added to the resin material includes at least one of acicular particles or tabular particles. As the resin material for the head housing unit 300, a modified polyphenylene ether obtained by blending polyphenylene ether (PPE) resin with polystyrene (PS) may be used, for example. A mixture of a glass filler and an inorganic filler is added to the resin material at 35%. Note that the head housing unit 300 is formed by assembling multiple parts obtained by injection molding using the resin material. In this way, in the head housing unit 300, part of a mechanism for positioning relative to the carriage 10 and liquid channels for supplying the inks to the ejection element substrate 110 (e.g., a supply-side liquid channel 401 and a collection-side liquid channel 402 illustrated in FIG. 4 to be described later) is formed. The circulation units 200 is fixed to the inside of the head housing unit 300 using screws 205 and forms of part of the liquid channels. The portions of the liquid channels connecting the circulation units 200 and the head housing unit 300 are sealed using seal members. As the seal members, elastic members made of rubber, an elastomer, or the like are used. The ejection element unit 100 is adhesively fixed to a lower portion of the head housing unit 300 and forms part of the liquid channels. The portions of the liquid channels connecting the head housing unit 300 and the ejection element unit 100 are sealed using elastic members.

The cover 350 is formed in a lid shape using a resin material. The cover 350 covers an opening formed at the top of the head housing unit 300 and is attached to the head housing unit 300. Thus, the three circulation units 200 for the three types of ink are accommodated in the head housing unit 300 to which the cover 350 is attached.

FIG. 4 is a schematic diagram illustrating a circulation path for the ink supplied from the first storage tank 21 in a steady state. Note that circulation paths for the inks from the second storage tank 22 and the third storage tank 23 are similar to the circulation path for the ink supplied from the first storage tank 21, and detailed illustration and description thereof are omitted. The ink stored in the first storage tank 21 is supplied under pressure to the first liquid ejection head 50 through the supply tube 30 by a supply pump P0 of the supply unit 20. At this time, the ink stored in the first storage tank 21 is supplied to the liquid supply port 32 of the circulation unit 200 through the supply tube 30 and the tube connecting portion 31. The ink supplied to the liquid supply port 32 undergoes removal of dust and the like through a filter 204 of the circulation unit 200 and then reaches the first pressure adjustment mechanism 201. In FIG. 4, "L" written on the first pressure adjustment mechanism 201 indicates that the negative pressure therein is low. "H" described on the second pressure adjustment mechanism 202 indicates that the negative pressure therein is high. The relationship of pressure magnitudes in FIG. 4 is the reverse of that based on positive pressure.

The first pressure adjustment mechanism 201 adjusts the pressure on the ink inside a first pressure control chamber 211 to a predetermined pressure (negative pressure). The first pressure control chamber 211 is connected to a common supply channel 111 in the ejection element substrate 110 through a supply-side retaining channel 411 and supply-side connection channels 421 forming a supply-side liquid channel 401. The supply-side retaining channel 411 is formed in the head housing unit 300. The supply-side connection channels 421 are formed in the support member 102. The supply-side liquid channel 401 communicates with the first pressure control chamber 211 in the circulation unit 200 and an ejection port array in the ejection element substrate 110.

The second pressure adjustment mechanism 202 adjusts the pressure on the ink inside a second pressure control chamber 221 to a pressure (negative pressure) lower than that inside the first pressure control chamber 211. The second pressure control chamber 221 is connected to a common collection channel 112 in the ejection element substrate 110 through a collection-side retaining channel 412 and collection-side connection channels 422 forming a collection-side liquid channel 402. The collection-side retaining channel 412 is formed in the head housing unit 300. The collection-side connection channels 422 are formed in the support member 102. The collection-side liquid channel 402 communicates with the second pressure control chamber 221 in the circulation unit 200 and the ejection port array in the ejection element substrate 110. In a case where the first liquid ejection head 50 ejects three types of ink, three supply-side liquid channels 401 and collection-side liquid channels 402 provided for the three types of ink are arranged alternately and adjacently in the X direction.

The circulation pump 203 sends the ink from the second pressure control chamber 221 on the lower pressure side (higher negative pressure side) to the first pressure control chamber 211 on the higher pressure side (lower negative pressure side). The circulation pumps 203 is constructed using a piezoelectric diaphragm pump, for example. The piezoelectric diaphragm pump inputs a drive voltage to a piezoelectric element attached to a diaphragm to change the inner volume of a pump chamber such that two check valves are alternately moved by the pressure changes. As a result, the ink is sent.

In the ejection element substrate 110, multiple pressure chambers 113 communicating the multiple ejection ports 115 (see FIG. 5) are formed. The common supply channel 111 and the common collection channel 112 are connected to the multiple pressure chambers 113. The common supply channel 111 is connected to the first pressure control chamber 211 in the circulation unit 200 through the supply-side connection channels 421 and the supply-side retaining channel 411. As a result, the pressure on the ink inside the common supply channel 111 is adjusted to the higher pressure side (lower negative pressure side), and the common supply channel 111 is connected to the upstream sides of the pressure chambers 113. The common collection channel 112 is connected to the second pressure control chamber 221 through the collection-side connection channels 422 and the collection-side retaining channel 412. As a result, the pressure on the ink inside the common collection channel 112 is adjusted to the lower pressure side (higher negative pressure side), and the common collection channel 112 is connected to the downstream sides of the pressure chambers 113. The pressure difference between the pressure on the ink inside the common supply channel 111 and the pressure on the ink inside the common collection channel 112 generates an ink flow in each pressure chamber 113 in the direction indicated by an arrow α in FIG. 4. In a case where the ink is not ejected from the ejection ports 115 during standby or printing, the viscosity of the ink locally increases in the vicinity of the ejection ports 115. The ink having undergone the local increase in viscosity in the vicinity of the ejection ports 115 is collected from the pressure chambers 113 by the ink flow generated by the above pressure difference. This can prevent ejection failure which would otherwise occur due to the local increase in the viscosity of the ink in the vicinity of the ejection ports 115.

### Configuration of Ejection Element Substrate

Next, the ejection element substrate 110 will be described. FIG. 5 is a perspective view illustrating a cross section of the ejection element substrate 110. As illustrated in FIG. 5, the ejection element substrate 110 includes a silicon substrate 150, a cover plate 151, an ejection port forming member 152, and ejection elements 154. The silicon substrate 150 is formed in a thin plate shape using silicon (Si) or the like. The ejection port forming member 152 is laminated on one surface of the silicon substrate 150. The cover plate 151 is joined to the other surface of the silicon substrate 150.

The ejection port forming member 152 is formed using a photosensitive resin in a thin plate shape that conforms to the outer peripheral shape of the silicon substrate 150. For example, the ejection port forming member 152 is formed using photolithography to pattern the ejection ports 115 and the pressure chambers 113. In the ejection port forming member 152, ejection port arrays are formed each of which is multiple ejection ports 115 arranged in a line in the Y direction. Note that multiple ejection port arrays are arranged side by side in the X direction in the ejection port forming member 152. In the example illustrated in FIG. 5, three ejection port arrays for three types of ink are arranged, but two ejection port arrays may be arranged or four or more ejection port arrays may be arranged. On the opposite side of the ejection port forming member 152, the multiple pressure chambers 113 communicating with the multiple ejection port arrays (ejection ports 115) are formed.

Also, multiple ejection elements 154 which generate ejection energy for ejecting the inks from the multiple ejection ports 115 are formed on the one surface of the silicon substrate 150. On the one surface of the silicon substrate 150, the ejection elements 154 are arranged to face the pressure chambers 113 (ejection ports 115). The ejection elements 154 eject the inks by generating bubbles in the inks inside the pressure chambers 113 by using electrothermal conversion elements. Note that the ejection elements 154 are not limited to electrothermal conversion elements and may be constructed using piezoelectric elements.

Behind the ejection elements 154 on the silicon substrate 150, groove forming the common supply channels 111 and the common collection channels 112 are formed. The common supply channels 111 and the common collection channels 112 extend in the direction along the ejection port arrays (Y direction). Supply ports 113a are formed at portions of the silicon substrate 150 between the pressure chambers 113 and the common supply channels 111. The supply ports 113a allow the pressure chambers 113 and the common supply channels 111 to communicate with each other. Collection ports 113b are formed at portions of the silicon substrate 150 between the pressure chambers 113 and the common collection channels 112. The collection ports 113b allow the pressure chambers 113 and the common collection channels 112 to communicate with each other.

The cover plate 151 is formed using, for example, silicon or the like in a thin plate shape that conforms to the outer peripheral shape of the silicon substrate 150. The cover plate 151 functions as a lid that forms part of the walls of the common supply channels 111 and the common collection channels 112 formed in the silicon substrate 150. In the cover plate 151, multiple supply channel openings 121 and multiple collection channel openings 122 are formed. The supply channel openings 121 are formed in an elongated shape to be arrayed in the direction along the ejection port arrays (Y direction) and communicate with the common supply channels 111. The collection channel openings 122 are formed in an elongated shape to be arrayed in the direction along the ejection port arrays (Y direction) and communicate with the common collection channels 112. Also, the collection channel openings 122 are arranged to be offset from the supply channel openings 121 in the Y direction.

### Configurations of Pressure Adjustment Mechanisms

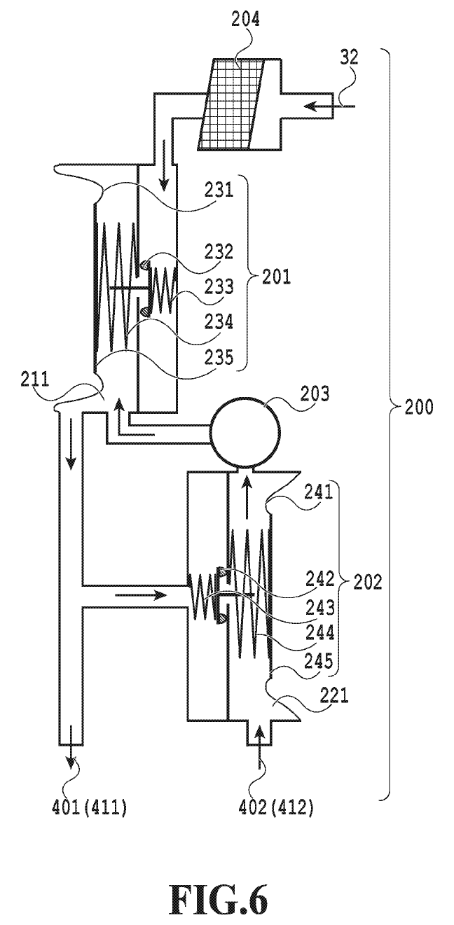

Next, the first pressure adjustment mechanism 201 and the second pressure adjustment mechanism 202 of each circulation unit 200 will be described. FIG. 6 is a schematic diagram illustrating the inside of a circulation unit 200. As illustrated in FIG. 6, the first pressure adjustment mechanism 201 includes a first valve 232, a first valve spring 233, a first flexible member 231, a first pressing plate 235, and a first pressure adjustment spring 234.

As the volume of the first pressure control chamber 211 decreases due to ink ejection or the like, the first pressing plate 235 deforms the first flexible member 231 and the first pressure adjustment spring 234 to maintain the pressure on the ink inside the first pressure control chamber 211. As the first pressure adjustment spring 234 undergoes compressive deformation, the first valve spring 233 is deformed in a compressing direction by means of the first valve 232, so that the first valve 232 is opened and the ink from the liquid supply port 32 is supplied into the first pressure control chamber 211. Thus, the first pressure adjustment mechanism 201 can maintain the pressure on the ink inside the first pressure control chamber 211 at a predetermined pressure (negative pressure). The negative pressure inside the first pressure control chamber 211 is set based on the position of contact of the first pressure adjustment spring 234 and the first valve 232 with the first pressing plate 235.

The second pressure adjustment mechanism 202 includes a second valve 242, a second valve spring 243, a second flexible member 241, a second pressing plate 245, and a second pressure adjustment spring 244. The second pressure adjustment mechanism 202 is configured similarly tot the first pressure adjustment mechanism 201 except that the ink is supplied from the first pressure control chamber 211. Thus, the second pressure adjustment mechanism 202 can maintain the pressure on the ink inside the second pressure control chamber 221 at a pressure (negative pressure) lower than that inside the first pressure control chamber 211.

As mentioned earlier, the circulation pump 203 sends the ink inside the second pressure control chamber 221 to the first pressure control chamber 211. As the circulation pump 203 sends the ink from the second pressure control chamber 221 to the first pressure control chamber 211, the negative pressure on the ink inside the first pressure control chamber 211 decreases and the negative pressure on the ink inside the second pressure control chamber 221 increases. As the negative pressure of the ink inside the second pressure control chamber 221 increases, the ink to be supplied from the first pressure control chamber 211 to the pressure chambers 113 is collected into the second pressure control chamber 221. This generates an ink flow that circulates through the first pressure control chamber 211, the pressure chambers 113, and the second pressure control chamber 221 in a state where the pressure on the ink inside the first pressure control chamber 211 and the second pressure control chamber 221 is maintained constant. Hereinafter, the ink flow that circulates through the first pressure control chamber 211, the pressure chambers 113, and the second pressure control chamber 221 will be referred to as "circulatory flow." By generating the ink circulatory flow that passes through the pressure chambers 113, the ink whose viscosity has locally increased in the vicinity of the ejection ports 115 can be removed from the pressure chambers 113. This allows for stable ejection of the ink from the ejection ports 115.

### Connection of Channels in Liquid Ejection Head

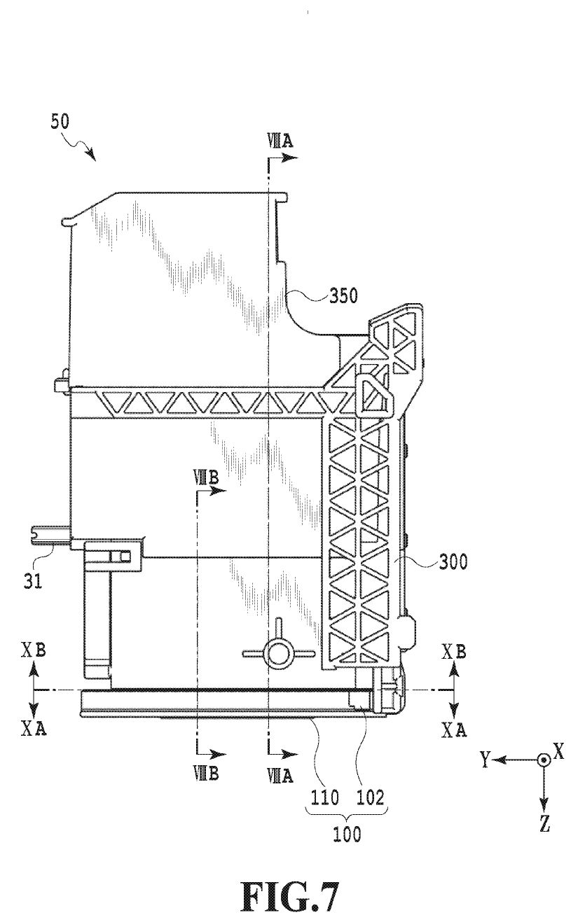

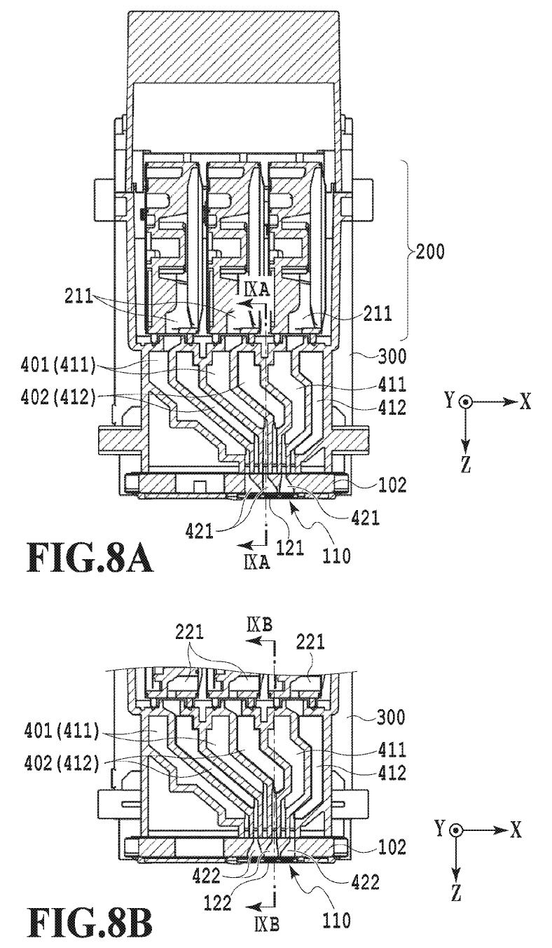

Next, the connection of channels in the first liquid ejection head 50 will be described. FIG. 7 is a side view of the first liquid ejection head 50. FIGS. 8A and 8B are cross-sectional views of the first liquid ejection head 50. FIG. 8A is a cross-sectional view taken along the line VIIIA-VIIIA in FIG. 7. FIG. 8B is a cross-sectional view taken along the line VIIIB-VIIIB in FIG. 7. The ejection element substrate 110 ejects the inks downward in the vertical direction (+Z direction) from the ejection port arrays extending along the sub scanning direction mentioned earlier (Y direction).

The cross-sectional view of FIG. 8A illustrates supply channel openings 121 of the ejection element substrate 110. The supply channel openings 121 are connected to the supply-side connection channels 421 formed in the support member 102. The supply-side connection channels 421 are connected to the supply-side retaining channels 411 formed in the head housing unit 300. The supply-side retaining channels 411 are connected to the first pressure control chambers 211 formed in the circulation units 200. Thus, the first pressure control chambers 211 in the circulation units 200 are connected to the common supply channels 111 (see FIG. 5) in the ejection element substrate 110 through the supply-side retaining channels 411, the supply-side connection channels 421, and the supply channel openings 121.

The cross-sectional view of FIG. 8B illustrates collection channel openings 122 of the ejection element substrate 110. The collection channel openings 122 are connected to the collection-side connection channels 422 formed in the support member 102. The collection-side connection channels 422 are connected to the collection-side retaining channels 412 formed in the head housing unit 300. The collection-side retaining channels 412 are connected to the second pressure control chambers 221 formed in the circulation units 200. Thus, the second pressure control chambers 221 in the circulation units 200 are connected to the common collection channels 112 (see FIG. 5) in the ejection element substrate 110 through the collection-side retaining channels 412, the collection-side connection channels 422, and the collection channel openings 122.

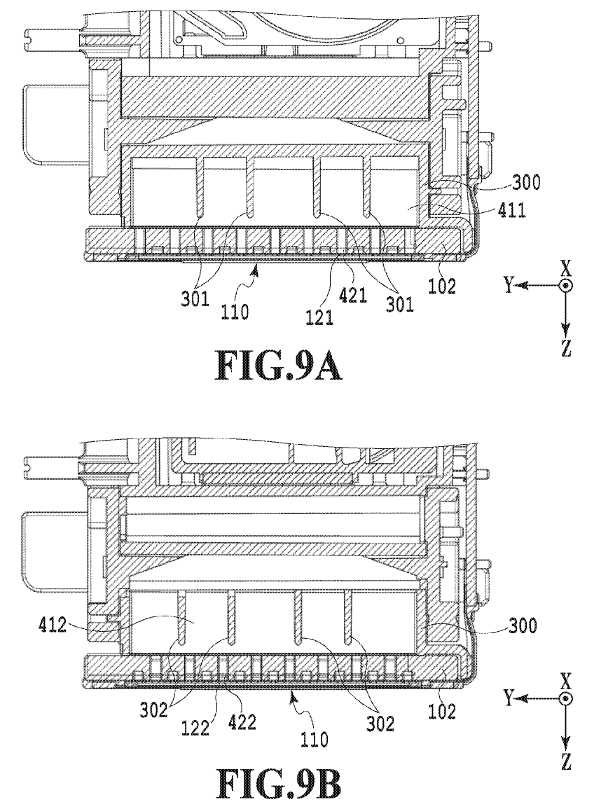

FIGS. 9A and 9B are side cross-sectional views of the first liquid ejection head 50. FIG. 9A is a cross-sectional view taken along the line IXA-IXA in FIG. 8A. FIG. 9B is a cross-sectional view taken along the line IXB-IXB in FIG. 8B. As illustrated in FIG. 9A, each supply-side retaining channel 411 is formed in a channel shape that has an elongated cross section narrow in the X direction and wide in the Y direction and is long in the Z direction. The supply-side retaining channel 411 is capable of retaining bubbles. Four supply-side beam portions 301 arranged side by side in the Y direction are formed on lower (+Z side) wall portions of the supply-side retaining channel 411 in the head housing unit 300. The supply-side beam portions 301 are formed in a beam shape extending along the Z direction. The four supply-side beam portions 301 divide the lower side of the supply-side retaining channel 411 into five parallel channels. The supply-side beam portions 301 improve the moldability of the supply-side retaining channel 411 and can thus reduce deformation of the supply-side retaining channel 411. Also, the support member 102 has the supply-side connection channels 421 formed to be divided such that they are positionally aligned with nine supply channel openings 121 arrayed in the direction along the ejection port arrays (Y direction). The nine supply-side connection channels 421 arrayed in the direction along the ejection port arrays (Y direction) are connected to the supply-side retaining channel 411 having an elongated shape in cross section.

As illustrated in FIG. 9B, each collection-side retaining channel 412 is formed in a channel shape that has an elongated cross section narrow in the X direction and wide in the Y direction and is long in the Z direction. The collection-side retaining channel 412 is capable of retaining bubbles. Four collection-side beam portions 302 arranged side by side in the Y direction are formed on lower (+Z side) wall portions of the collection-side retaining channel 412 in the head housing unit 300. The collection-side beam portions 302 are formed in a beam shape extending along the Z direction. The four collection-side beam portions 302 divide the lower side of the collection-side retaining channel 412 into five parallel channels. The collection-side beam portions 302 improve the moldability of the collection-side retaining channel 412 and can thus reduce deformation of the collection-side retaining channel 412. Also, the support member 102 has the collection-side connection channels 422 formed to be divided such that they are positionally aligned with eight collection channel openings 122 arrayed in the direction along the ejection port arrays (Y direction). The eight collection-side connection channels 422 arrayed in the direction along the ejection port arrays (Y direction) are connected to the collection-side retaining channel 412 having an elongated shape in cross section.

As illustrated in FIG. 8A, the inks having flowed out from the first pressure control chambers 211 of the circulation units 200 flow into the common supply channels 111 in the ejection element substrate 110 through the supply-side retaining channels 411, the supply-side connection channels 421, and the supply channel openings 121. Note that part of the inks having flowed out from the first pressure control chambers 211 flow into the second pressure adjustment mechanisms 202. As illustrated in FIG. 5, the inks having reached the common supply channels 111 in the ejection element substrate 110 flow into the pressure chambers 113 through the supply ports 113a. The inks inside the pressure chambers 113 that are not ejected from the ejection ports 115 flow into the common collection channels 112 through the collection ports 113b. As illustrated in FIG. 8B, the inks having reached the common collection channels 112 in the ejection element substrate 110 flow into the second pressure control chambers 221 in the circulation units 200 through the collection channel openings 122, the collection-side connection channels 422, and the collection-side retaining channels 412. The inks having flowed into the second pressure control chambers 221 are sent to the first pressure control chambers 211 by the circulation pumps 203. Ink circulatory flows are generated inside the first liquid ejection head 50 in this manner.

The ink circulatory flows are completed within the liquid channels in the first liquid ejection head 50. For this reason, bubbles (not illustrated) formed inside the liquid channels in the first liquid ejection head 50 are present at some portions of the ink circulatory flows. The bubbles are formed due to foaming caused by ink filling, ink flow, and the like, a decrease in the solubility of gas in the inks caused by a temperature increase or a pressure decrease, and so on. If bubbles flow into the pressure chambers 113, they may cause ink ejection failure and deteriorate the print quality. For this reason, it is desirable to retain the bubbles in the supply-side retaining channels 411 or the collection-side retaining channels 412, which are located far from the pressure chambers 113, in order to prevent the bubbles from flowing into the pressure chambers 113. Since the supply-side retaining channels 411 and the collection-side retaining channels 412 are formed in a channel shape that has an elongated shape in cross section, it is possible to collect and retain the bubbles using buoyancy.

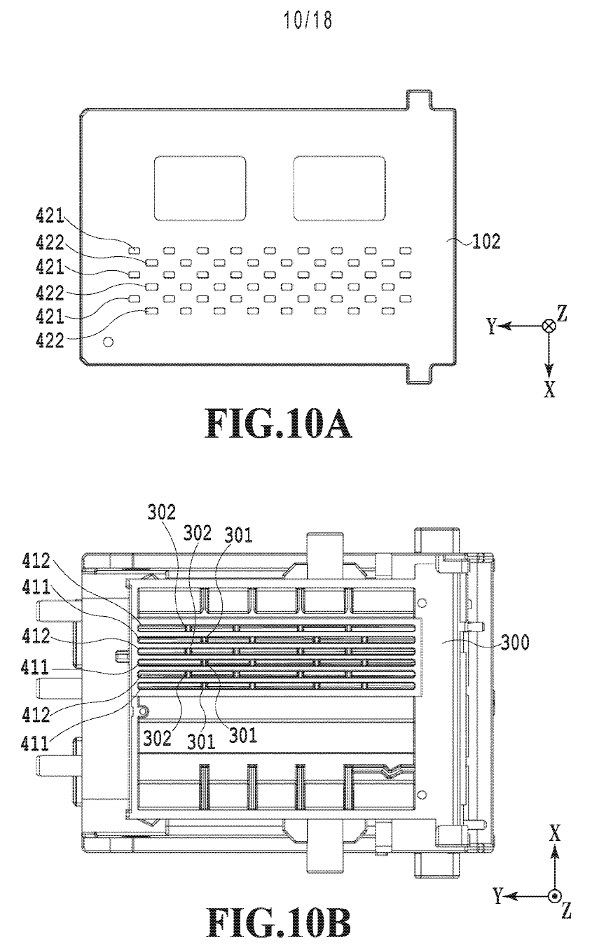

FIGS. 10A and 10B are horizontal cross-sectional views of the first liquid ejection head 50. FIG. 10A is a cross-sectional view taken along the line XA-XA in FIG. 7. FIG. 10B is a cross-sectional view taken along the line XB-XB in FIG. 7. In the first liquid ejection head 50, three sets of liquid channels (supply-side liquid channels 401 and collection-side liquid channels 402) for the three types of ink are provided. The supply-side liquid channels 401 are formed between the circulation units 200 and the ejection element substrate 110 by connecting the supply-side retaining channels 411 and the supply-side connection channels 421. The collection-side liquid channels 402 are formed between the circulation units 200 and the ejection element substrate 110 by connecting the collection-side retaining channels 412 and the collection-side connection channels 422. As illustrated in FIG. 10A, in the support member 102, arrays of supply-side connection channels 421 arranged in a line in the direction along the ejection port arrays (Y direction) and arrays of collection-side connection channels 422 arranged in a line in the direction along the ejection port arrays are formed alternately in the X direction. As illustrated in FIG. 10B, in the head housing unit 300, the supply-side retaining channels 411 having an elongated shape in cross section and the collection-side retaining channels 412 having an elongated shape in cross section are formed alternately and adjacently in the X direction.

As a method of downsizing the ejection element substrate 110 for cost reduction, it is conceivable to reduce the width of the ejection element substrate 110 in the X direction, which does not affect the print speed. In this case, the liquid channels for supplying the inks to the ejection element substrate 110 need to be individually connected to the ejection element substrate 110 with the narrow width in the X direction, and the openings of the liquid channels need to be formed with high accuracy.

As illustrated in FIGS. 8A and 8B, the lower openings of the supply-side retaining channels 411 and the collection-side retaining channels 412 in the head housing unit 300 are connected to the supply-side connection channels 421 and the collection-side connection channels 422, which are arranged at narrow pitches in the X direction that match the ejection element substrate 110. The upper openings of the supply-side retaining channels 411 and the collection-side retaining channels 412 are connected to the first pressure control chambers 211 and the second pressure control chambers 221 in the circulation units 200, which are arranged at wide pitches in the X direction. Thus, the supply-side retaining channels 411 and the collection-side retaining channels 412 are each formed in a channel shape that has an elongated cross section narrow in the X direction and wide in the Y direction and is long in the Z direction. Also, the pitches in the X direction at which the supply-side retaining channels 411 and the collection-side retaining channels 412 are alternately arranged increase toward the circulation units 200 from the ejection element substrate 110. To form such supply-side retaining channels 411 and collection-side retaining channels 412 with a small number of parts, it is desirable to manufacture the head housing unit 300 by injection molding.

Also, the three supply-side retaining channels 411 and the three collection-side retaining channels 412 provided for the three types of ink are arranged alternately and adjacently in the X direction. Four supply-side beam portions 301 arranged side by side in the Y direction are formed on lower (+Z side) wall portions of each supply-side retaining channel 411 in the head housing unit 300. Four collection-side beam portions 302 arranged side by side in the Y direction are formed on lower wall portions of each collection-side retaining channel 412 in the head housing unit 300. This improves the moldability of the supply-side retaining channels 411 and the collection-side retaining channels 412. Accordingly, the lower (+Z side) openings of the supply-side retaining channels 411 and the collection-side retaining channels 412 can be formed with high accuracy.

In the present embodiment, the length of each ejection port array in the ejection element substrate 110 is 1.6 inches. The lower side of each supply-side retaining channel 411 is divided by the four supply-side beam portions 301 into five channels having widths of 0.25 inch or more and 0.4 inch or less in the Y direction. The lower side of each collect-side retaining channel 412 is divided by the four collection-side beam portions 302 into five channels having widths of 0.25 inch or more and 0.4 inch or less in the Y direction. It is desirable to dispose the four supply-side beam portions 301 such that the Y-direction widths of the channels on the lower side of the supply-side retaining channel 411 are 0.5 inch (12.7 mm) or less. Also, it is desirable to dispose the four collection-side beam portions 302 such that the Y-direction widths of the channels on the lower side of the collection-side retaining channel 412 are 0.5 inch or less. This can reduce deformation of the supply-side retaining channel 411 and the collection-side retaining channel 412.

Also, it is desirable to employ the supply-side retaining channels 411 and the collection-side retaining channels 412 for a liquid ejection head whose ejection port arrays have a length of 0.5 inch or more. The length of each ejection port array represents the distance from the ejection port 115 arranged at one end of the ejection port array to the ejection port 115 arranged at the other end of the ejection port array. The length of each ejection port array can be set within a range that does not exceed the diameter of the wafer to be used to manufacture the ejection element substrate 110. For example, the length of each ejection port array may be 12 inches or less or 8 inches or less. The length of each ejection port array may be 2 inches or less for the purpose of suppressing an increase in the manufacturing costs of the ejection element substrate 110.

Also, the support member 102 and the head housing unit 300 are bonded by an adhesive (not illustrated). As the adhesive, a thermosetting epoxy resin adhesive is used, for example. The thermosetting epoxy resin adhesive is a thermosetting adhesive containing an epoxy resin as its main component. The thermosetting epoxy resin adhesive has high chemical resistance and bonding strength and is thus compatible with various types of ink. Using the thermosetting epoxy resin adhesive involves a heating process in a curing oven or the like, so that a stress is generated in the support member 102 and the head housing unit 300 by a difference in thermal contraction after the joining. The stress by the difference in thermal contraction after the joining increases according to the temperature during the joining, the difference in coefficient of linear expansion between the material of the head housing unit 300 and the material of the support member 102, and the length of the joined portion between the support member 102 and the head housing unit 300. The coefficient of linear expansion of alumina, which is the material of the support member 102, is 7.2 ppm/°C. The coefficient of linear expansion of the filler-containing resin which is the material of the head housing unit 300 is 39.0 ppm/°C. The difference between the coefficient of linear expansion of the material of the head housing unit 300 and the coefficient of linear expansion of the material of the support member 102 is 31.8 ppm/°C. Thus, the difference (absolute value) between the coefficient of linear expansion of the material of the head housing unit 300 and the coefficient of linear expansion of the material of the support member 102 is 6 ppm/°C or more. Accordingly, the supply-side beam portions 301 and the collection-side beam portions 302 of the head housing unit 300 contract more greatly than the support member 102, and high tensile stresses are generated in the supply-side beam portions 301 and the collection-side beam portions 302.

If the supply-side beam portions 301 of the supply-side retaining channels 411 and the collection-side beam portions 302 of the collection-side retaining channels 412 adjacent to the supply-side retaining channels 411 are arranged at the same positions in the Y direction, stress concentration occurs at the supply-side beam portions 301 and the collection-side beam portions 302. This leads to a possibility of breakage of the supply-side beam portions 301 and the collection-side beam portions 302 by a stress generated by the difference in thermal contraction between the support member 102 and the head housing unit 300 after the joining. The supply-side beam portions 301 and the collection-side beam portions 302 may break not only due to the stress generated by the difference in thermal contraction between the support member 102 and the head housing unit 300 after the joining but also due to that by the environmental temperature as the environment in which the liquid ejection apparatus 1 is used becomes low in temperature. That is, regardless of whether the support member 102 and the head housing unit 300 are adhesively fixed, the supply-side beam portions 301 and the collection-side beam portions 302 may break due to a stress generated by a change in temperature from that during the joining. Moreover, in a case of joining the support member 102 and the head housing unit 300 by thermal welding, press fitting, or the like instead of adhesive fixing, the supply-side beam portions 301 and the collection-side beam portions 302 may still break due to a stress generated by a change in temperature from that during the joining. Furthermore, in a case where the material of the support member 102 and the material of the head housing unit 300 are the same, the supply-side beam portions 301 and the collection-side beam portions 302 may still break due to the stress generated by the shape-induced anisotropy of the coefficient of linear expansion, the shape-induced difference in contraction, and/or the like.

In the present embodiment, the supply-side beam portions 301 of the supply-side retaining channels 411 and the collection-side beam portions 302 of the collection-side retaining channels 412 adjacent to the supply-side retaining channels 411 are arranged to be offset from each other in the direction along the ejection port arrays (Y direction). This can alleviate the stress generated in the supply-side beam portions 301 and the collection-side beam portions 302 after the joining of the support member 102 and the head housing unit 300 and thus prevent breakage of the supply-side beam portions 301 and the collection-side beam portions 302. Accordingly, it is possible to provide a liquid ejection head with high reliability capable of preventing breakage of the supply-side beam portions 301 and the collection-side beam portions 302. Also, the four supply-side beam portions 301 of the supply-side retaining channels 411 and the four collection-side beam portions 302 of the collection-side retaining channels 412 adjacent to the supply-side retaining channels 411 may be arranged to be offset from each other by an equal distance. In this way, the five channels on the lower sides of the supply-side retaining channels 411 divided by the four supply-side beam portions 301 and the five channels on the lower sides of the collection-side retaining channels 412 divided by the four collection-side beam portions 302 are unlikely to be uneven. This maintains the moldability of the supply-side retaining channels 411 and the collection-side retaining channels 412. Accordingly, the lower (+Z side) openings of the supply-side retaining channels 411 and the collection-side retaining channels 412 can be formed with high accuracy. In this case, the arrangement of the four supply-side beam portions 301 and the four collection-side beam portions 302 in the direction in which the supply-side retaining channels 411 and the collection-side retaining channels 412 are arranged side by side (X direction) is desirably a staggered arrangement.

As described above, according to the first embodiment, it is possible to provide a liquid ejection head with high reliability. Specifically, in the present embodiment, in the head housing unit 300, which is a first channel member, there are formed the sets of supply-side beam portions 301 dividing part of the supply-side liquid channels 401, in particular the lower sides of the supply-side retaining channels 411, into multiple parallel channels. Also, in the head housing unit 300, there are formed the sets of collection-side beam portions 302 dividing part of the collection-side liquid channels 402, in particular the lower sides of the collection-side retaining channels 412, into multiple parallel channels. Moreover, the supply-side beam portions 301 and the collection-side beam portions 302 in the adjacent supply-side retaining channels 411 and collection-side retaining channels 412 are arranged to be offset from each other in the direction along the ejection port arrays. This can alleviate the stress generated in the supply-side beam portions 301 and the collection-side beam portions 302 after the joining of the support member 102 and the head housing unit 300 and thus prevent breakage of the supply-side beam portions 301 and the collection-side beam portions 302. In this way, a liquid ejection head with high reliability can be provided.

Also, the amount of offset between the supply-side beam portions 301 and the collection-side beam portions 302 in the adjacent supply-side retaining channels 411 and collection-side retaining channels 412 is the same for each of the four supply-side beam portions 301 and the four collection-side beam portions 302. In this way, the five channels on the lower sides of the supply-side retaining channels 411 divided by the four supply-side beam portions 301 and the five channels on the lower sides of the collection-side retaining channels 412 divided by the four collection-side beam portions 302 are unlikely to be uneven. This maintains the moldability of the supply-side retaining channels 411 and the collection-side retaining channels 412. Accordingly, the lower openings of the supply-side retaining channels 411 and the collection-side retaining channels 412 can be formed with high accuracy.

Also, the support member 102, which is a second channel member, is formed using alumina. The thermal conductivity of alumina is high, and the coefficient of linear expansion of alumina is low. This makes it possible to reduce the stress to be generated in the ejection element substrate 110 supported by the support member 102 and make the internal temperature of the ejection element substrate 110 uniform.

In the first embodiment described above, the supply-side beam portions 301 and the collection-side beam portions 302 in the adjacent supply-side retaining channels 411 and collection-side retaining channels 412 are arranged to be offset from each other in the direction along the ejection port arrays, but the arrangement is not limited to this. For example, the supply-side beam portions 301 and the collection-side beam portions 302 in the adjacent supply-side retaining channels 411 and collection-side retaining channels 412 are arranged to be offset from each other in the direction in which the ejection ports 115 extend (Z direction).

### Second Embodiment

Next, a second embodiment will be described. Some members in the second embodiment have similar configurations to those in the above first embodiment. Thus, the description will be given with the same reference signs given to these members as those in the above first embodiment. In the second embodiment, the second liquid ejection head 60 configured similarly to the first liquid ejection head 50 will be described.

### Configuration of Liquid Ejection Head

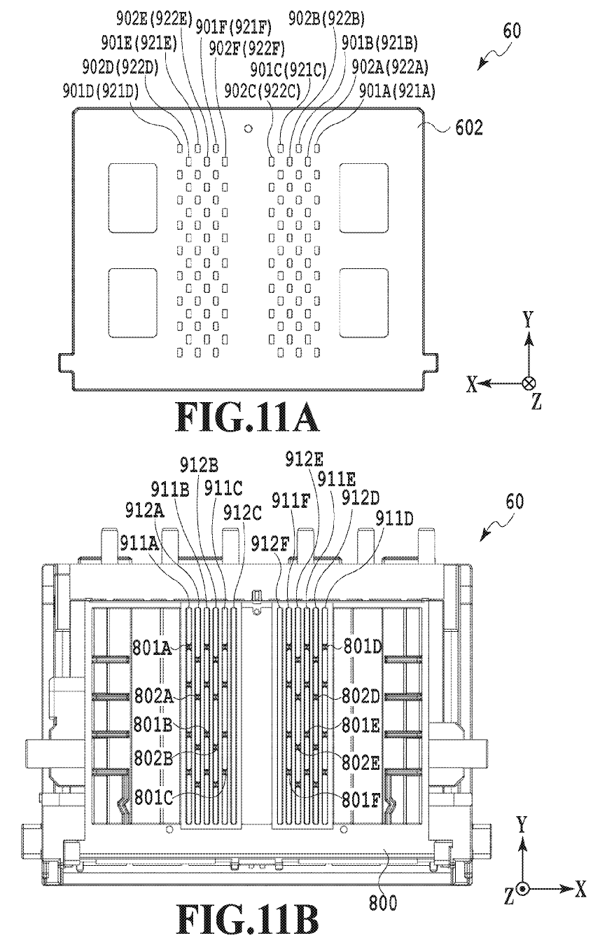

FIGS. 11A and 11B are horizontal cross-sectional views of the second liquid ejection head 60. FIG. 11A is a horizontal cross-sectional view illustrating a support member 602 of the second liquid ejection head 60. FIG. 11B is a horizontal cross-sectional view illustrating a head housing unit 800 of the second liquid ejection head 60. The second liquid ejection head 60 is configured similarly to the first liquid ejection head 50 except for the support member 602 and the head housing unit 800. The support member 602 in the second embodiment is configured similarly to the support member 102 in the first embodiment except that the support member 602 supports two ejection element substrates 110. The head housing unit 800 in the second embodiment is configured similarly to the head housing unit 300 in the first embodiment except that the head housing unit 800 is capable of accommodating six circulation units 200.

As illustrated in FIGS. 11A and 11B, in the second liquid ejection head 60, six sets of liquid channels for six types of ink are provided. The six sets of liquid channels include first to sixth supply-side liquid channels 901A to 901F and first to sixth collection-side liquid channels 902A to 902F and are formed by the head housing unit 800 and the support member 602. First to sixth supply-side retaining channels 911A to 911F forming the first to sixth supply-side liquid channels 901A to 901F are formed in the head housing unit 800. First to sixth supply-side connection channels 921A to 921F forming the first to sixth supply-side liquid channels 901A to 901F are formed in the support member 602. First to sixth collection-side retaining channels 912A to 912F forming the first to sixth collection-side liquid channels 902A to 902F are formed in the head housing unit 800. First to sixth collection-side connection channels 922A to 922F forming the first to sixth collection-side liquid channels 902A to 902F are formed in the support member 602.

As illustrated in FIG. 11B, the first to sixth supply-side retaining channels 911A to 911F are formed similarly to the supply-side retaining channels 411 in the first embodiment. For example, the first supply-side retaining channel 911A is connected to the first pressure control chamber 211 in the circulation unit 200 to which an ink is supplied from the fourth storage tank 24 (see FIG. 1). The second supply-side retaining channel 911B is connected to the first pressure control chamber 211 in the circulation unit 200 to which an ink is supplied from the fifth storage tank 25 (see FIG. 1). The third supply-side retaining channel 911C is connected to the first pressure control chamber 211 in the circulation unit 200 to which an ink is supplied from the sixth storage tank 26 (see FIG. 1). The fourth supply-side retaining channel 911D is connected to the first pressure control chamber 211 in the circulation unit 200 to which an ink is supplied from the seventh storage tank 27 (see FIG. 1). The fifth supply-side retaining channel 911E is connected to the first pressure control chamber 211 in the circulation unit 200 to which an ink is supplied from the eighth storage tank 28 (see FIG. 1). The sixth supply-side retaining channel 911F is connected to the first pressure control chamber 211 in the circulation unit 200 to which an ink is supplied from the ninth storage tank 29 (see FIG. 1).

The first to sixth collection-side retaining channels 912A to 912F are formed similarly to the collection-side retaining channels 412 in the first embodiment. For example, the first collection-side retaining channel 912A is connected to the second pressure control chamber 221 in the circulation unit 200 to which an ink is supplied from the fourth storage tank 24. The second collection-side retaining channel 912B is connected to the second pressure control chamber 221 in the circulation unit 200 to which an ink is supplied from the fifth storage tank 25. The third collection-side retaining channel 912C is connected to the second pressure control chamber 221 in the circulation unit 200 to which an ink is supplied from the sixth storage tank 26. The fourth collection-side retaining channel 912D is connected to the second pressure control chamber 221 in the circulation unit 200 to which an ink is supplied from the seventh storage tank 27. The fifth collection-side retaining channel 912E is connected to the second pressure control chamber 221 in the circulation unit 200 to which an ink is supplied from the eighth storage tank 28. The sixth collection-side retaining channel 912F is connected to the second pressure control chamber 221 in the circulation unit 200 to which an ink is supplied from the ninth storage tank 29.

The first to third supply-side retaining channels 911A to 911C and the fourth to sixth supply-side retaining channels 911D to 911F are arranged to be line symmetric about the central line of the head housing unit 800 extending in the Y direction. The first to third collection-side retaining channels 912A to 912C and the fourth to sixth collection-side retaining channels 912D to 912F are arranged to be line symmetric about the central line of the head housing unit 800 extending in the Y direction. The first supply-side retaining channel 911A, the first collection-side retaining channel 912A, the second supply-side retaining channel 911B, the second collection-side retaining channel 912B, the third supply-side retaining channel 911C, and the third collection-side retaining channel 912C are arranged in this order from the edge side in the -X direction. Thus, the first to third supply-side retaining channels 911A to 911C and the first to third collection-side retaining channels 912A to 912C are formed alternately and adjacently in the X direction at a portion of the head housing unit 800 on the -X side. The fourth supply-side retaining channel 911D, the fourth collection-side retaining channel 912D, the fifth supply-side retaining channel 911E, the fifth collection-side retaining channel 912E, the sixth supply-side retaining channel 911F, and the sixth collection-side retaining channel 912F are arranged in this order from the edge side in the +X direction. Thus, the fourth to sixth supply-side retaining channels 911D to 911F and the fourth to sixth collection-side retaining channels 912D to 912F are formed alternately and adjacently in the X direction at a portion of the head housing unit 800 on the +X side.

As illustrated in FIG. 11A, the first to sixth supply-side connection channels 921A to 921F are formed similarly to the supply-side connection channels 421 in the first embodiment and connected to the supply channel openings 121 in the ejection element substrates 110. For example, the first supply-side connection channels 921A are connected to the first supply-side retaining channel 911A in the head housing unit 800. The second supply-side connection channels 921B are connected to the second supply-side retaining channel 911B in the head housing unit 800. The third supply-side connection channels 921C are connected to the third supply-side retaining channel 911C in the head housing unit 800. The fourth supply-side connection channels 921D are connected to the fourth supply-side retaining channel 911D in the head housing unit 800. The fifth supply-side connection channels 921E are connected to the fifth supply-side retaining channel 911E in the head housing unit 800. The sixth supply-side connection channels 921F are connected to the sixth supply-side retaining channel 911F in the head housing unit 800.

The first to sixth collection-side connection channels 922A to 922F are formed similarly to the collection-side connection channels 422 in the first embodiment and connected to the collection channel openings 122 in the ejection element substrates 110. For example, the first collection-side connection channels 922A are connected to the first collection-side retaining channel 912A in the head housing unit 800. The second collection-side connection channels 922B are connected to the second collection-side retaining channel 912B in the head housing unit 800. The third collection-side connection channels 922C are connected to the third collection-side retaining channel 912C in the head housing unit 800. The fourth collection-side connection channels 922D are connected to the fourth collection-side retaining channel 912D in the head housing unit 800. The fifth collection-side connection channels 922E are connected to the fifth collection-side retaining channel 912E in the head housing unit 800. The sixth collection-side connection channels 922F are connected to the sixth collection-side retaining channel 912F in the head housing unit 800.

The first to third supply-side connection channels 921A to 921C and the fourth to sixth supply-side connection channels 921D to 921F are formed to be line symmetric about the central line of the support member 602 extending in the Y direction. The first to third collection-side connection channels 922A to 922C and the fourth to sixth collection-side connection channels 922D to 922F are formed to be line symmetric about the central line of the support member 602 extending in the Y direction. The first supply-side connection channels 921A, the first collection-side connection channels 922A, the second supply-side connection channels 921B, the second collection-side connection channels 922B, the third supply-side connection channels 921C, and the third collection-side connection channels 922C are arranged in this order from the edge side in the -X direction. Thus, arrays of first to third supply-side connection channels 921A to 921C and arrays of first to third collection-side connection channels 922A to 922C are formed alternately in the X direction at a portion of the support member 602 on the -X side. The fourth supply-side connection channels 921D, the fourth collection-side connection channels 922D, the fifth supply-side connection channels 921E, the fifth collection-side connection channels 922E, the sixth supply-side connection channels 921F, and the sixth collection-side connection channels 922F are arranged in this order form the edge side in the +X direction. Thus, arrays of fourth to sixth supply-side connection channels 921D to 921F and arrays of fourth to sixth collection-side connection channels 922D to 922F are formed alternately in the X direction at a portion of the support member 602 on the +X side.

The support member 602 is formed using alumina, as in the first embodiment. The head housing unit 800 is formed using a resin material to which a filler is added, as in the first embodiment. The second liquid ejection head 60 is larger than the first liquid ejection head 50. Accordingly, the stress generated by the change in temperature from during the joining of the support member 602 and the head housing unit 800 is greater than the stress generated in the first liquid ejection head 50.

Four first supply-side beam portions 801A arranged side by side in the Y direction are formed on lower (+Z side) wall portions of the first supply-side retaining channel 911A in the head housing unit 800. Four first collection-side beam portions 802A arranged side by side in the Y direction are formed on lower wall portions of the first collection-side retaining channel 912A in the head housing unit 800. Four second supply-side beam portions 801B arranged side by side in the Y direction are formed on lower wall portions of the second supply-side retaining channel 911B in the head housing unit 800. Four second collection-side beam portions 802B arranged side by side in the Y direction are formed on lower wall portions of the second collection-side retaining channel 912B in the head housing unit 800. Four third supply-side beam portions 801C arranged side by side in the Y direction are formed on lower wall portions of the third supply-side retaining channel 911C in the head housing unit 800. No third collection-side beam portions are formed on wall portions of the third collection-side retaining channel 912C in the head housing unit 800.

Four fourth supply-side beam portions 801D arranged side by side in the Y direction are formed on lower wall portions of the fourth supply-side retaining channel 911D in the head housing unit 800. Four fourth collection-side beam portions 802D arranged side by side in the Y direction are formed on lower wall portions of the fourth collection-side retaining channel 912D in the head housing unit 800. Four fifth supply-side beam portions 801E arranged side by side in the Y direction are formed on lower wall portions of the fifth supply-side retaining channel 911E in the head housing unit 800. Four fifth collection-side beam portions 802E arranged side by side in the Y direction are formed on lower wall portions of the fifth collection-side retaining channel 912E in the head housing unit 800. Four sixth supply-side beam portions 801F arranged side by side in the Y direction are formed on lower wall portions of the sixth supply-side retaining channel 911F in the head housing unit 800. No sixth collection-side beam portions are formed on wall portions of the sixth collection-side retaining channel 912F in the head housing unit 800.

In this way, the moldability of the first to sixth supply-side retaining channels 911A to 911F and the first to sixth collection-side retaining channels 912A to 912F is improved. Accordingly, the lower (+Z side) openings of the first to sixth supply-side retaining channels 911A to 911F and the first to sixth collection-side retaining channels 912A to 912F can be formed with high accuracy.

Note that no beam portions are formed on wall portions of the third collection-side retaining channel 912C and the sixth collection-side retaining channel 912F in the head housing unit 800. This divides the transfer of the stress generated by the change in temperature from that during the joining of the support member 602 and the head housing unit 800 at the third collection-side retaining channel 912C and the sixth collection-side retaining channel 912F, in which no beam portions are arranged. This can in turn reduce part of the stress generated by the change in temperature from that during the joining of the support member 602 and the head housing unit 800 that is transferred to the beam portions. By disposing no beam portions in the third collection-side retaining channel 912C and the sixth collection-side retaining channel 912F, the maximum stress to be applied to the beam portions can be reduced to half or less as compared to a case where beam portions are arranged in all of the retaining channels. Also, beam portions are arranged in the third collection-side retaining channel 912C and the sixth collection-side retaining channel 912F, which are located around the center of the head housing unit 800. This can reduce the stress to be transferred to the beam portions without affecting the moldability and accuracy of the first to sixth supply-side retaining channels 911A to 911F and the first to sixth collection-side retaining channels 912A to 912F.

As described above, the first to third supply-side retaining channels 911A to 911C and the first to third collection-side retaining channels 912A to 912C are formed alternately and adjacently in the X direction at a portion of the head housing unit 800 on the -X side. The first collection-side beam portions 802A and the second collection-side beam portions 802B are arranged to be offset from the first supply-side beam portions 801A, the second supply-side beam portions 801B, and the third supply-side beam portions 801C in the direction along the ejection port arrays (Y direction). Also, the fourth to sixth supply-side retaining channels 911D to 911F and the fourth to sixth collection-side retaining channels 912D to 912F are formed alternately and adjacently in the X direction at a portion of the head housing unit 800 on the +X side. The fourth collection-side beam portions 802D and the fifth collection-side beam portions 802E are arranged to be offset from the fourth supply-side beam portions 801D, the fifth supply-side beam portions 801E, and the sixth supply-side beam portions 801F in the direction along the ejection port arrays. This can alleviate the stress generated in the beam portions after the joining of the support member 602 and the head housing unit 800 and thus prevent breakage of the beam portions. Accordingly, it is possible to provide a liquid ejection head with high reliability capable of preventing breakage of its beam portions.

Also, the four first collection-side beam portions 802A and the four second collection-side beam portions 802B may be arranged to be offset from the four first supply-side beam portions 801A, the four second supply-side beam portions 801B, and the four third supply-side beam portions 801C by an equal distance. The four fourth collection-side beam portions 802D and the four fifth collection-side beam portions 802E may be arranged to be offset from the four fourth supply-side beam portions 801D, the four fifth supply-side beam portions 801E, and the four sixth supply-side beam portions 801F by an equal distance. This improves the moldability of the first to sixth supply-side retaining channels 911A to 911F and the first to sixth collection-side retaining channels 912A to 912F, as in the first embodiment. Accordingly, the lower (+Z side) openings of the first to sixth supply-side retaining channels 911A to 911F and the first to sixth collection-side retaining channels 912A to 912F can be formed with high accuracy. In this case, the arrangement of the four first supply-side beam portions 801A, the four first collection-side beam portions 802A, the four second supply-side beam portions 801B, the four second collection-side beam portions 802B, and the four third supply-side beam portions 801C along the direction in which the retaining channels are arranged side by side (X direction) is desirably a staggered arrangement. The arrangement of the four fourth supply-side beam portions 801D, the four fourth collection-side beam portions 802D, the four fifth supply-side beam portions 801E, the four fifth collection-side beam portions 802E, and the four sixth supply-side beam portions 801F along the direction in which the retaining channels are arranged side by side (X direction) is desirably a staggered arrangement.

As described above, according to the second embodiment, it is possible to provide a liquid ejection head with high reliability, as in the first embodiment. Also, in the second embodiment, no beam portions are formed on wall portions of the third collection-side retaining channel 912C and the sixth collection-side retaining channel 912F in the head housing unit 800. This can reduce part of the stress generated by the change in temperature from that during the joining of the support member 602 and the head housing unit 800 that is transferred to the beam portions.

Also, the amount of offset between the supply-side beam portions and the collection-side beam portions in the adjacent supply-side retaining channels and collection-side retaining channels among the first to third supply-side retaining channels and the first and second collection-side retaining channels is the same for each of the four supply-side beam portions and the four collection-side beam portions. Also, the amount of offset between the supply-side beam portions and the collection-side beam portions in the adjacent supply-side retaining channels and collection-side retaining channels among the fourth to sixth supply-side retaining channels and the fourth and fifth collection-side retaining channels is the same for each of the four supply-side beam portions and the four collection-side beam portions. In this way, the lower openings of the first to sixth supply-side retaining channels and the first to sixth collection-side retaining channels can be formed with high accuracy, as in the first embodiment.

Also, the support member 602, which is a second channel member, is formed using alumina. This makes it possible to reduce the stress to be generated in the ejection element substrate 110 supported by the support member 602 and make the internal temperature of the ejection element substrate 110 uniform, as in the first embodiment.

In the second embodiment described above, no beam portions are formed in wall portions of the third collection-side retaining channel 912C and the sixth collection-side retaining channel 912F in the head housing unit 800, but the configuration is not limited to this. For example, no beam portions may be formed in the wall portions of the second supply-side retaining channel 911B and the fifth supply-side retaining channel 911E in the head housing unit 800 in addition to the wall portions of the third collection-side retaining channel 912C and the sixth collection-side retaining channel 912F. This can further reduce the part of the stress generated by the change in temperature from that during the joining of the support member 602 and the head housing unit 800 that is transferred to the beam portions. Thus, no beam portions may be arranged in some of the multiple retaining channels (liquid channels).

Also, a smaller number of third collection-side beam portions than the number of first supply-side beam portions 801A, first collection-side beam portions 802A, or the like may be formed on the wall portion of the third collection-side retaining channel 912C. A smaller number of sixth collection-side beam portions than the number of fourth supply-side beam portions 801D, fourth collection-side beam portions 802D, or the like may be formed on the wall portion of the sixth collection-side retaining channel 912F. As described above, the number of beam portions in some of the multiple retaining channels (liquid channels) may be smaller than the number of beam portions in the other retaining channels excluding the some retaining channel or channels. This can also reduce part of the stress generated by the change in temperature from that during the joining of the support member 602 and the head housing unit 800 that is transferred to the beam portions.

Also, the first collection-side beam portions 802A and the second collection-side beam portions 802B are arranged to be offset from the first supply-side beam portions 801A, the second supply-side beam portions 801B, and the third supply-side beam portions 801C in the direction along the ejection port arrays, but the arrangement is not limited to this. The fourth collection-side beam portions 802D and the fifth collection-side beam portions 802E are arranged to be offset from the fourth supply-side beam portions 801D, the fifth supply-side beam portions 801E, and the sixth supply-side beam portions 801F in the direction along the ejection port arrays, but the arrangement is not limited to this. For example, the first collection-side beam portions 802A and the second collection-side beam portions 802B may be arranged to be offset from the first supply-side beam portions 801A, the second supply-side beam portions 801B, and the third supply-side beam portions 801C in the direction in which the ejection ports 115 extend (Z direction). The fourth collection-side beam portions 802D and the fifth collection-side beam portions 802E may be arranged to be offset from the fourth supply-side beam portions 801D, the fifth supply-side beam portions 801E, and the sixth supply-side beam portions 801F in the direction in which the ejection ports 115 extend.

### Third Embodiment

Next, a third embodiment will be described. Some members in the third embodiment have similar configurations to those in the above first embodiment. Thus, the description will be given with the same reference signs given to these members as those in the above first embodiment. In the third embodiment, a liquid ejection head without ink circulation paths will be described.

### Configuration of Liquid Ejection Head

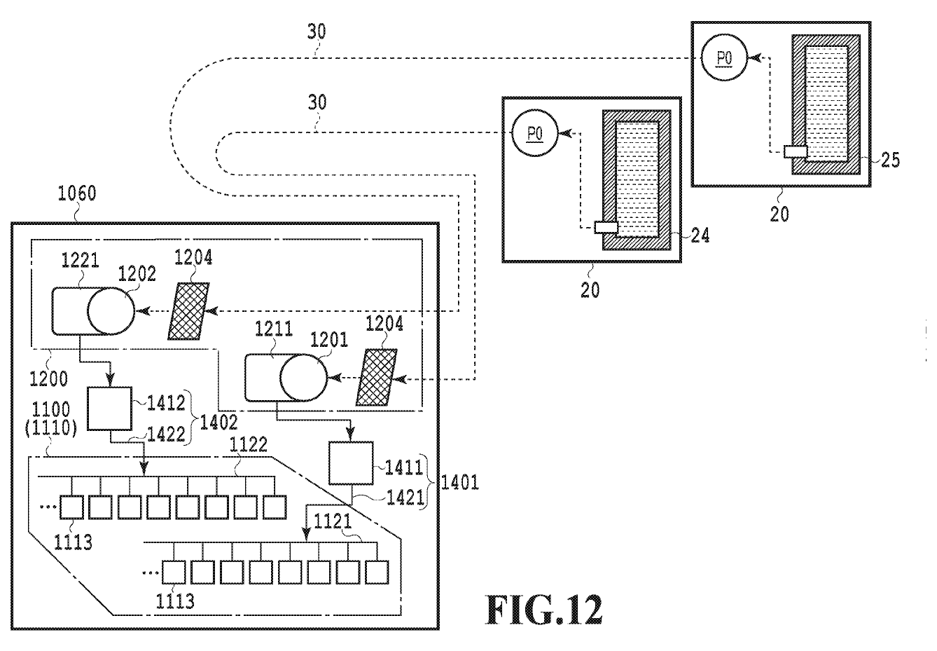

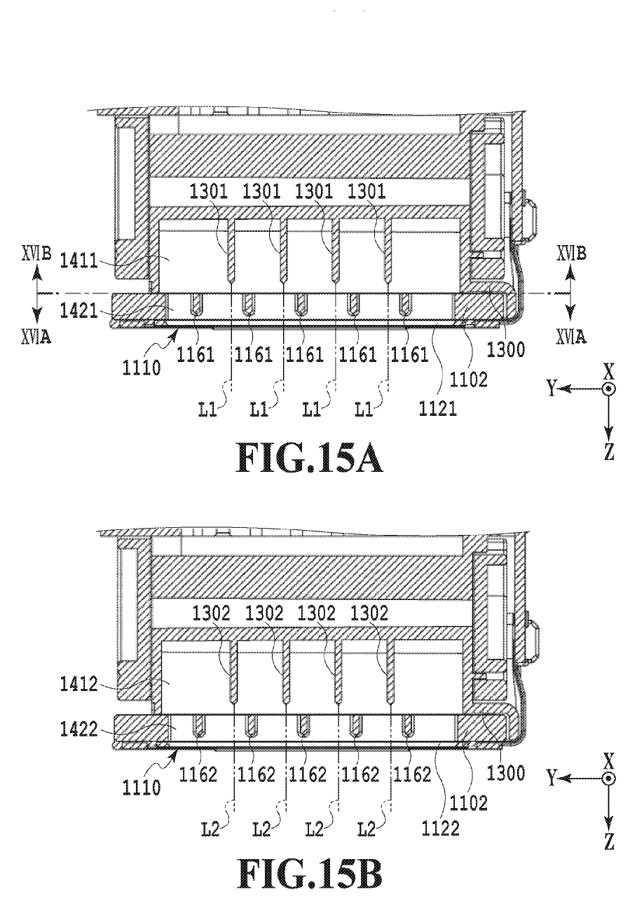

FIG. 12 is a schematic diagram illustrating ink supply paths in the third embodiment. As illustrated in FIG. 12, a second liquid ejection head 1060 in the third embodiment includes an ejection element unit 1100, a pressure adjustment unit 1200, a head housing unit 1300 (see FIGS. 15A and 15B to be described later), and a cover (not illustrated).

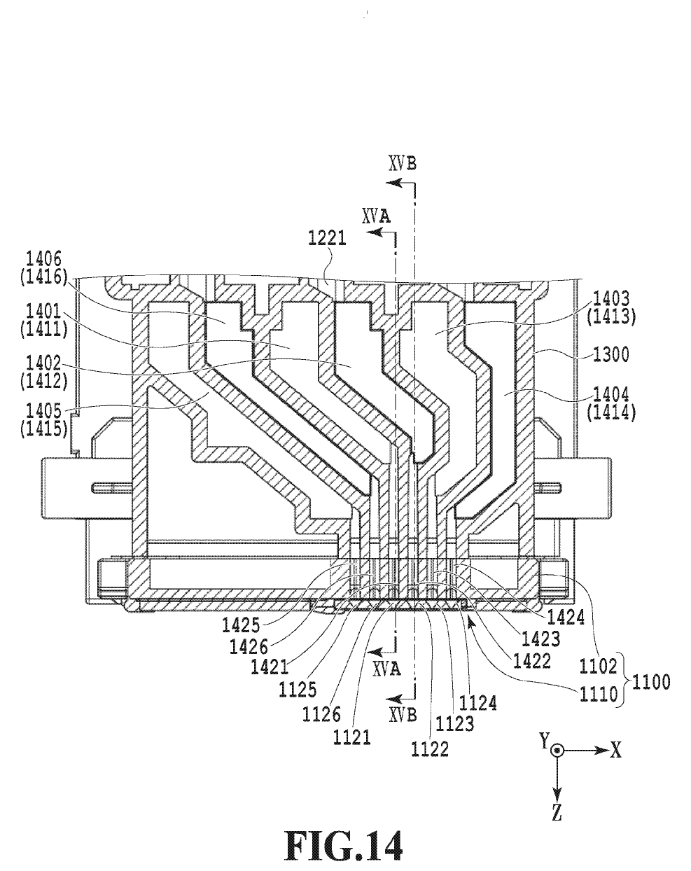

The ejection element unit 1100 includes an ejection element substrate 1110, a support member 1102 (see FIG. 14 to be described later), electric wiring tape (not illustrated), and an electric contact substrate (not illustrated). The electric wiring tape and the electric contact substrate in the third embodiment are configured similarly to the electric wiring tape 103 and the electric contact substrate 104 in the first embodiment. Thus, detailed illustration and description of the electric wiring tape and the electric contact substrate are omitted. Note that the electric contact substrate sends drive signals and electric energy for ink ejection to the ejection element substrate 1110 through the electric wiring tape. Details of the ejection element substrate 1110 and the support member 1102 will be described later.

The pressure adjustment unit 1200 includes first to sixth pressure adjustment mechanisms for six types of ink and filters 1204. For example, the first pressure adjustment mechanism denoted by reference sign 1201 is supplied with the ink stored in the fourth storage tank 24, and the second pressure adjustment mechanism denoted by reference sign 1202 is supplied with the ink stored in the fifth storage tank 25. The third pressure adjustment mechanism (not illustrated) is supplied with the ink stored in the sixth storage tank 26 (see FIG. 1), and the fourth pressure adjustment mechanism (not illustrated) is supplied with the ink stored in the seventh storage tank 27 (see FIG. 1). The fifth pressure adjustment mechanism (not illustrated) is supplied with the ink stored in the eighth storage tank 28 (see FIG. 1), and the sixth pressure adjustment mechanism (not illustrated) is supplied with the ink stored in the ninth storage tank 29 (see FIG. 1). The first to sixth pressure adjustment mechanisms are configured similarly to the first pressure adjustment mechanism 201 in the first embodiment. Note that the supply paths for the inks to be supplied from the sixth to ninth storage tanks 26 to 29 are similar to the supply paths for the inks to be supplied from the fourth storage tank 24 and the fifth storage tank 25, and detailed illustration and description thereof are omitted.

The ink stored in the fourth storage tank 24 is supplied under pressure to the second liquid ejection head 1060 through the corresponding supply tube 30 by the corresponding supply pump P0 of the supply unit 20. The ink supplied from the fourth storage tank 24 to the second liquid ejection head 1060 undergoes removal of dust and the like through the corresponding filter 1204 of the pressure adjustment unit 1200 and then reaches the first pressure adjustment mechanism 1201. The ink stored in the fifth storage tank 25 is supplied under pressure to the second liquid ejection head 1060 through the corresponding supply tube 30 by the corresponding supply pump P0 of the supply unit 20. The ink supplied from the fifth storage tank 25 to the second liquid ejection head 1060 undergoes removal of dust and the like through the corresponding filter 1204 of the pressure adjustment unit 1200 and then reaches the second pressure adjustment mechanism 1202.

The first pressure adjustment mechanism 1201 adjusts the pressure on the ink inside a first pressure control chamber 1211 to a predetermined pressure (negative pressure). The first pressure control chamber 1211 is connected to a first supply path 1121 in the ejection element substrate 1110 through a first retaining channel 1411 and a first connection channel 1421 forming a first liquid channel 1401. The first retaining channel 1411 is formed in the head housing unit 1300. The first connection channel 1421 is formed in the support member 1102. The first liquid channel 1401 communicates with the first pressure control chamber 1211 in the pressure adjustment unit 1200 and pressure chambers 1113 (ejection port array) in the ejection element substrate 1110. The ink inside the first pressure control chamber 1211 after the pressure adjustment by the first pressure adjustment mechanism 1201 is supplied to the pressure chambers 1113 in the ejection element substrate 1110 through the first retaining channel 1411, the first connection channel 1421, and the first supply path 1121.

The second pressure adjustment mechanism 1202 adjusts the pressure on the ink inside a second pressure control chamber 1221 to the same pressure (negative pressure) as that inside the first pressure control chamber 1211. The second pressure control chamber 1221 is connected to a second supply path 1122 in the ejection element substrate 1110 through a second retaining channel 1412 and a second connection channel 1422 forming a second liquid channel 1402. The second retaining channel 1412 is formed in the head housing unit 1300. The second connection channel 1422 is formed in the support member 1102. The second liquid channel 1402 communicates with the second pressure control chamber 1221 in the pressure adjustment unit 1200 and pressure chambers 1113 (ejection port array) in the ejection element substrate 1110. The ink inside the second pressure control chamber 1221 after the pressure adjustment by the second pressure adjustment mechanism 1202 is supplied to the pressure chambers 1113 in the ejection element substrate 1110 through the second retaining channel 1412, the second connection channel 1422, and the second supply path 1122. Note that, in the case where the second liquid ejection head 1060 ejects six types of ink, six liquid channels for the six types of ink are arranged adjacently in the X direction.

### Configuration of Ejection Element Substrate

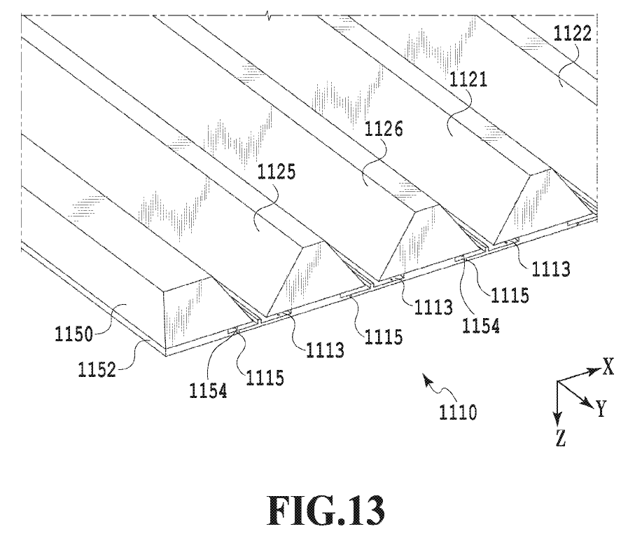

Next, the ejection element substrate 1110 in the third embodiment will be described. FIG. 13 is a perspective view illustrating a cross section of the ejection element substrate 1110 in the third embodiment. As illustrated in FIG. 13, the ejection element substrate 1110 in the third embodiment includes a silicon substrate 1150, an ejection port forming member 1152, and ejection elements 1154. The ejection element substrate 1110 ejects the inks downward in the vertical direction (+Z direction) from the ejection port arrays extending in the sub scanning direction mentioned earlier (Y direction). The silicon substrate 1150 is formed in a thin plate shape using silicon (Si) or the like. The ejection port forming member 1152 is laminated on one surface of the silicon substrate 1150.

The ejection port forming member 1152 is formed using a photosensitive resin in a thin plate shape that conforms to the outer peripheral shape of the silicon substrate 1150. For example, the ejection port forming member 1152 is formed using photolithography to pattern the ejection ports 1115 and the pressure chambers 1113. In the ejection port forming member 1152, ejection port arrays are formed each of which is multiple ejection ports 1115 arranged in a line in the Y direction. Note that multiple ejection port arrays are arranged side by side in the X direction in the ejection port forming member 1152. For example, in the ejection port forming member 1152, 6 ejection port arrays each of which corresponds to one of the six types of ink may be arranged, or 12 ejection port arrays each two of which correspond to one of the six types of ink may be arranged. Also, in the ejection port forming member 1152, five or fewer ejection port arrays may be arranged, or seven or more ejection port arrays may be arranged. On the opposite side of the ejection port forming member 1152, the multiple pressure chambers 1113 communicating with the multiple ejection port arrays (ejection ports 1115) are formed.

Also, multiple ejection elements 1154 which generate ejection energy for ejecting the inks from the multiple ejection ports 1115 are formed on the one surface of the silicon substrate 1150. On the one surface of the silicon substrate 1150, the ejection elements 1154 are arranged to face the pressure chambers 1113 (ejection ports 1115). The ejection elements 1154 eject the inks by generating bubbles in the inks inside the pressure chambers 1113 by using electrothermal conversion elements. Note that the ejection elements 1154 are not limited to electrothermal conversion elements and may be constructed using piezoelectric elements.

Behind ejection element 1154 on the silicon substrate 1150, supply paths communicating with the pressure chambers 1113, such as the first supply path 1121 and the second supply path 1122, are formed. The supply paths, such as the first supply path 1121 and the second supply path 1122, are formed in a groove shape extending the direction along the ejection port arrays (Y direction).

### Configurations of Head Housing Unit and Support Member

Next, the head housing unit 1300 and the support member 1102 in the third embodiment will be described. FIG. 14 is a partial cross-sectional view of the second liquid ejection head 1060 in the third embodiment. The head housing unit 1300 in the third embodiment is configured similarly to the head housing unit 300 in the first embodiment except that the head housing unit 1300 is capable of accommodating the pressure adjustment unit 1200. Also, the cover in the third embodiment (not illustrated) is formed similarly to the cover 350 in the first embodiment. The pressure adjustment unit 1200 is accommodated in the head housing unit 1300 to which the cover is attached.

As illustrated in FIG. 14, at a lower portion of the head housing unit 1300, the first and second retaining channels 1411 and 1412 and third to sixth retaining channels 1413 to 1416 for the six types of ink are formed adjacently in the X direction. The head housing unit 1300 forms the upstream sides of the first and second liquid channels 1401 and 1402 and third to sixth liquid channels 1403 to 1406. The first retaining channel 1411 is connected to the first pressure control chamber 1211 in the pressure adjustment unit 1200. The second retaining channel 1412 is formed adjacently to the +X side of the first retaining channel 1411 and connected to the second pressure control chamber 1221 in the pressure adjustment unit 1200. The third retaining channel 1413 is formed adjacently to the +X side of the second retaining channel 1412 and connected to a third pressure control chamber (not illustrated) in the pressure adjustment unit 1200. The fourth retaining channel 1414 is formed adjacently to the +X side of the third retaining channel 1413 and connected to a fourth pressure control chamber (not illustrated) in the pressure adjustment unit 1200. The sixth retaining channel 1416 is formed adjacently to the -X side of the first retaining channel 1411 and connected to a sixth pressure control chamber (not illustrated) in the pressure adjustment unit 1200. The fifth retaining channel 1415 is formed adjacently to the -X side of the sixth retaining channel 1416 and connected to a fifth pressure control chamber (not illustrated) in the pressure adjustment unit 1200.

The support member 1102 supports the ejection element substrate 1110 and is adhesively fixed to a lower portion of the head housing unit 1300. The support member 1102 supports the ejection element substrate 1110 in a state where it is joined to the ejection element substrate 1110. The support member 1102 is formed in a plate shape using a resin material to which a filler with high heat resistance is added. Note that the filler added to the resin material may include at least one of acicular particles or tabular particles. In a case of adjusting the temperature of the ejection element substrate 1110 by heating it based on the inks' characteristics, using a resin with low thermal conductivity as the material for the support member 1102 can shorten the rise time for the temperature adjustment and thus improve the energy efficiency. Also, the coefficient of linear expansion of the resin material of the support member 1102 is lower than the coefficient of linear expansion of the resin material of the head housing unit 1300. This reduces the difference between the coefficient of linear expansion of the resin material of the support member 1102 and the coefficient of linear expansion of the material of the ejection element substrate 1110. Accordingly, the stress to be generated in the ejection element substrate 1110 supported on the support member 1102 can be reduced.

In the support member 1102, the first and second connection channels 1421 and 1422 and third to sixth connection channels 1423 to 1426 for the six types of ink are formed adjacently in the X direction. The support member 1102 forms the downstream sides of the first to sixth liquid channels 1401 to 1406. The upstream side of the first connection channel 1421 is connected to the first retaining channel 1411 formed in the head housing unit 1300, and the downstream side of the first connection channel 1421 is connected to the first supply path 1121 formed in the ejection element substrate 1110. The second connection channel 1422 is formed adjacently to the +X side of the first connection channel 1421. The upstream side of the second connection channel 1422 is connected to the second retaining channel 1412 formed in the head housing unit 1300, and the downstream side of the second connection channel 1422 is connected to the second supply path 1122 formed in the ejection element substrate 1110.

The third connection channel 1423 is formed adjacently to the +X side of the second connection channel 1422. The upstream side of the third connection channel 1423 is connected to the third retaining channel 1413 formed in the head housing unit 1300, and the downstream side of the third connection channel 1423 is connected to a third supply path 1123 formed in the ejection element substrate 1110. The fourth connection channel 1424 is formed adjacently to the +X side of the third connection channel 1423. The upstream side of the fourth connection channel 1424 is connected to the fourth retaining channel 1414 formed in the head housing unit 1300, and the downstream side of the fourth connection channel 1424 is connected to a fourth supply path 1124 formed in the ejection element substrate 1110. The sixth connection channel 1426 is formed adjacently to the -X side of the first connection channel 1421. The upstream side of the sixth connection channel 1426 is connected to the sixth retaining channel 1416 formed in the head housing unit 1300, and the downstream side of the sixth connection channel 1426 is connected to a sixth supply path 1126 formed in the ejection element substrate 1110. The fifth connection channel 1425 is formed adjacently to the -X side of the sixth connection channel 1426. The upstream side of the fifth connection channel 1425 is connected to the fifth retaining channel 1415 formed in the head housing unit 1300, and the downstream side of the fifth connection channel 1425 is connected to a fifth supply path 1125 formed in the ejection element substrate 1110.

FIGS. 15A and 15B are side cross-sectional views of the second liquid ejection head 1060 in the third embodiment. FIG. 15A is a cross-sectional view taken along the line XVA-XVA in FIG. 14. FIG. 15B is a cross-sectional view taken along the line XVB-XVB in FIG. 14.

The cross-sectional view of FIG. 15A illustrates the first retaining channel 1411 in the head housing unit 1300 and the first connection channel 1421 in the support member 1102. The first retaining channel 1411 is formed in a channel shape that has an elongated cross section narrow in the X direction and wide in the Y direction and is long in the Z direction. The first retaining channel 1411 is capable of retaining bubbles. Four first upstream beam portions 1301 arranged side by side in the Y direction are formed on lower (+Z side) wall portions of the first retaining channel 1411 in the head housing unit 1300. The first upstream beam portions 1301 are formed in a beam shape extending along the Z direction. The four first upstream beam portions 1301 divide the lower side of the first retaining channel 1411 into five parallel channels.

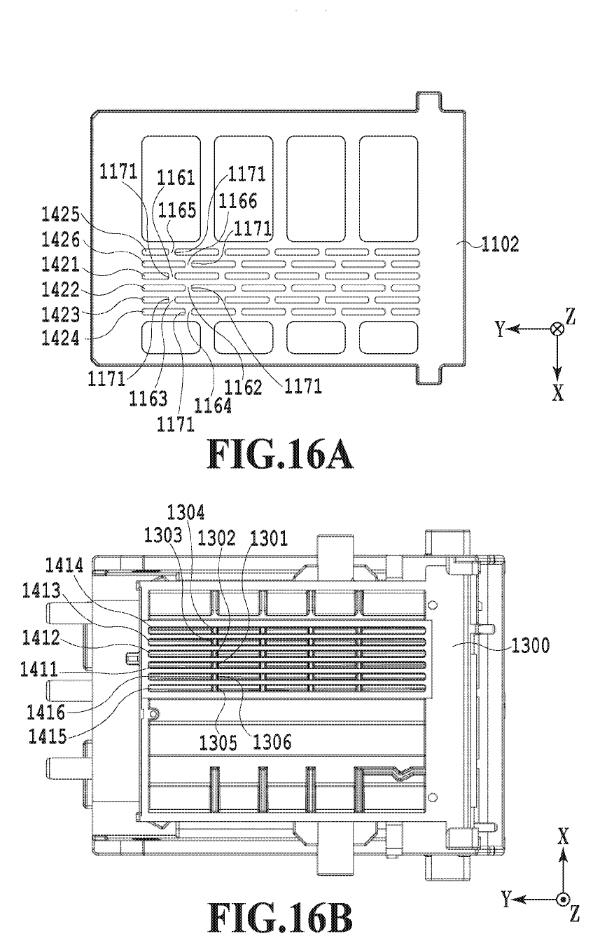

The first connection channel 1421 is formed in a channel shape that has an elongated cross section narrow in the X direction and wide in the Y direction and extends in the Z direction. Five first downstream beam portions 1161 arranged side by side in the Y direction are formed on wall portions of the first connection channel 1421 in the support member 1102. The first downstream beam portions 1161 are formed in a beam shape extending along the Z direction. Round downstream corner portions 1171 (see FIG. 16A to be described later) are formed at the connecting portions between the first downstream beam portions 1161 and the walls of the first connection channel 1421. The five first downstream beam portions 1161 divide the first connection channel 1421 connected to the downstream side of the first retaining channel 1411 into six parallel channels.

The cross-sectional view of FIG. 15B illustrates the second retaining channel 1412 in the head housing unit 1300 and the second connection channel 1422 in the support member 1102. The second retaining channel 1412 is formed in a channel shape that has an elongated cross section narrow in the X direction and wide in the Y direction and is long in the Z direction. The second retaining channel 1412 is capable of retaining bubbles. Four second upstream beam portions 1302 arranged side by side in the Y direction are formed on lower (+Z side) wall portions of the second retaining channel 1412 in the head housing unit 1300. The second upstream beam portions 1302 are formed in a beam shape extending along the Z direction. The four second upstream beam portions 1302 divide the lower side of the second retaining channel 1412 into five parallel channels.

The second connection channel 1422 is formed in a channel shape that has an elongated cross section narrow in the X direction and wide in the Y direction and extends in the Z direction. Five second downstream beam portions 1162 arranged side by side in the Y direction are formed on wall portions of the second connection channel 1422 in the support member 1102. The second downstream beam portions 1162 are formed in a beam shape extending along the Z direction. Round downstream corner portions 1171 (see FIG. 16A to be described later) are formed at the connecting portions between the second downstream beam portions 1162 and the walls of the second connection channel 1422. The five second downstream beam portions 1162 divide the second connection channel 1422 connected to the downstream side of the second retaining channel 1412 into six parallel channels.

Also, the third retaining channel 1413 (see FIG. 14) forming the third liquid channel 1403 is formed in a channel shape that has an elongated cross section narrow in the X direction and wide in the Y direction and is long in the Z direction. Four third upstream beam portions 1303 (see FIG. 16B to be described later) similar to the first upstream beam portions 1301 are formed on lower (+Z side) wall portions of the third retaining channel 1413 in the head housing unit 1300. The third connection channel 1423 (see FIG. 14) forming the third liquid channel 1403 is formed in a channel shape that has an elongated cross section narrow in the X direction and wide in the Y direction and extends in the Z direction. Five third downstream beam portions 1163 (see FIG. 16A to be described later) similar to the first downstream beam portions 1161 are formed on wall portions of the third connection channel 1423 in the support member 1102. Round downstream corner portions 1171 (see FIG. 16A to be described later) are formed at the connecting portions between the third downstream beam portions 1163 and the walls of the third connection channel 1423.

The fourth retaining channel 1414 (see FIG. 14) forming the fourth liquid channel 1404 is formed in a channel shape that has an elongated cross section narrow in the X direction and wide in the Y direction and is long in the Z direction. Four fourth upstream beam portions 1304 (see FIG. 16B to be described later) similar to the second upstream beam portions 1302 are formed on lower (+Z side) wall portions of the fourth retaining channel 1414 in the head housing unit 1300. The fourth connection channel 1424 (see FIG. 14) forming the fourth liquid channel 1404 is formed in a channel shape that has an elongated cross section narrow in the X direction and wide in the Y direction and extends in the Z direction. Five fourth downstream beam portions 1164 (see FIG. 16A to be described later) similar to the second downstream beam portions 1162 are formed on wall portions of the fourth connection channel 1424 in the support member 1102. Round downstream corner portions 1171 (see FIG. 16A to be described later) are formed at the connecting portions between the fourth downstream beam portions 1164 and the walls of the fourth connection channel 1424.

The fifth retaining channel 1415 (see FIG. 14) forming the fifth liquid channel 1405 is formed in a channel shape that has an elongated cross section narrow in the X direction and wide in the Y direction and is long in the Z direction. Four fifth upstream beam portions 1305 (see FIG. 16B to be described later) similar to the first upstream beam portions 1301 are formed on lower (+Z side) wall portions of the fifth retaining channel 1415 in the head housing unit 1300. The fifth connection channel 1425 (see FIG. 14) forming the fifth liquid channel 1405 is formed in a channel shape that has an elongated cross section narrow in the X direction and wide in the Y direction and extends in the Z direction. Five fifth downstream beam portions 1165 (see FIG. 16A to be described later) similar to the first downstream beam portions 1161 are formed on wall portions of the fifth connection channel 1425 in the support member 1102. Round downstream corner portions 1171 (see FIG. 16A to be described later) are formed at the connecting portions between the fifth downstream beam portions 1165 and the walls of the fifth connection channel 1425.

The sixth retaining channel 1416 (see FIG. 14) forming the sixth liquid channel 1406 is formed in a channel shape that has an elongated cross section narrow in the X direction and wide in the Y direction and is long in the Z direction. Four sixth upstream beam portions 1306 (see FIG. 16B to be described later) similar to the second upstream beam portions 1302 are formed on lower (+Z side) wall portions of the sixth retaining channel 1416 in the head housing unit 1300. The sixth connection channel 1426 (see FIG. 14) forming the sixth liquid channel 1406 is formed in a channel shape that has an elongated cross section narrow in the X direction and wide in the Y direction and extends in the Z direction. Five sixth downstream beam portions 1166 (see FIG. 16A to be described later) similar to the second downstream beam portions 1162 are formed on wall portions of the sixth connection channel 1426 in the support member 1102. Round downstream corner portions 1171 (see FIG. 16A to be described later) are formed at the connecting portions between the sixth downstream beam portions 1166 and the walls of the sixth connection channel 1426.

Also, as illustrated in FIG. 15A, the five first downstream beam portions 1161 are arranged to be situated on both sides of extension lines L1 extending from the four first upstream beam portions 1301 to the first connection channel 1421 on the downstream side of the first liquid channel 1401. In this way, the difference in flow velocity is small between the ink flows through the five channels on the lower side of the first retaining channel 1411 divided by the four first upstream beam portions 1301. Accordingly, fine bubbles included in the ink flowing through the first retaining channel 1411 will spread into the five channels on the lower side of the first retaining channel 1411 and will not aggregate at a certain position. As illustrated in FIG. 15B, the five second downstream beam portions 1162 are arranged to be situated on both sides of extension lines L2 extending from the four second upstream beam portions 1302 to the second connection channel 1422 on the downstream side of the second liquid channel 1402. In this way, the difference in flow velocity is small between the ink flows through the five channels on the lower side of the second retaining channel 1412 divided by the four second upstream beam portions 1302. Accordingly, fine bubbles included in the ink flowing through the second retaining channel 1412 will spread into the five channels on the lower side of the second retaining channel 1412 and will not aggregate at a certain position.

Also, like the first downstream beam portions 1161 and the second downstream beam portions 1162, the third to sixth downstream beam portion 1163 to 1166 are arranged to be situated on both sides of extension lines extending from the third to sixth upstream beam portions 1303 to 1306 to the third to sixth connection channels 1423 to 1426. In this way, the difference in flow velocity is small between the ink flows through the channels on the lower sides of the third to sixth retaining channels 1413 to 1416 divided by the third to sixth upstream beam portions 1303 to 1306. Accordingly, fine bubbles included in the inks flowing through the third to sixth retaining channels 1413 to 1416 will spread into the channels on the lower sides of the third to sixth retaining channels 1413 to 1416 and will not aggregate at certain positions. As described above, fine bubbles included in the inks flowing through the first to sixth retaining channels 1411 to 1416 are spread. This can prevent a deterioration in print quality. Accordingly, it is possible to provide a liquid ejection head with high robustness against bubbles formed inside the liquid ejection head.

FIGS. 16A and 16B are horizontal cross-sectional views of the second liquid ejection head 1060 in the third embodiment. FIG. 16A is a cross-sectional view taken along the line XVIA-XVIA in FIG. 15A. FIG. 16B is a cross-sectional view taken along the line XVIB-XVIB of FIG. 15A. As illustrated in FIG. 16B, at a lower portion of the head housing unit 1300, the first to sixth retaining channels 1411 to 1416 for the six types of ink are formed adjacently in the X direction. The first to sixth upstream beam portions 1301 to 1306 in the first to sixth retaining channels 1411 to 1416 are arranged at the same positions in the Y direction. This can reduce the resistance exerted on the resin that flows inside the mold during the injection molding. Accordingly, the injection molding for the head housing unit 1300 can be performed stably.

Also, the support member 1102 and the head housing unit 1300 are joined with an adhesive (not illustrated). As the adhesive, a thermosetting epoxy resin adhesive is used, for example. Using the thermosetting epoxy resin adhesive involves a heating process in a curing oven or the like, so that a stress is generated in the support member 1102 and the head housing unit 1300 by a difference in thermal contraction after the joining. The coefficient of linear expansion of the resin material of the support member 1102 is 25 ppm/°C. The coefficient of linear expansion of the resin material of the head housing unit 1300 is 39 ppm/°C. The difference (absolute value) between the coefficient of linear expansion of the resin material of the support member 1102 and the coefficient of linear expansion of the resin material of the head housing unit 1300 is 14 ppm/°C. Thus, the difference (absolute value) between the coefficient of linear expansion of the resin material of the support member 1102 and the coefficient of linear expansion of the resin material of the head housing unit 1300 is 6 ppm/°C or more. Thus, the support member 1102 contracts to a greater extent than the head housing unit 1300. Accordingly, the stress generated due to the change in temperature from that during the joining concentrates at the support member 1102, which has lower strength than the head housing unit 1300. Also, even in a case where the material of the support member 1102 and the material of the head housing unit 1300 are the same, a stress is still generated by the shape-induced anisotropy of the coefficient of linear expansion, the shape-induced difference in contraction, and/or the like, and concentrates at the support member 1102, which has lower strength than the head housing unit 1300.

As illustrated in FIG. 16B, in the support member 1102, the first to sixth connection channels 1421 to 1426 for the six types of ink are formed adjacently in the X direction. The second downstream beam portions 1162, the fourth downstream beam portions 1164, and the sixth downstream beam portions 1166 are arranged to be offset from the first downstream beam portions 1161, the third downstream beam portions 1163, and the fifth downstream beam portions 1165 in the direction along the ejection port arrays (Y direction). In other words, the downstream beam portions in adjacent connection channels among the first to sixth connection channels 1421 to 1426 are arranged to be offset from each other in the direction along the ejection port arrays. This can alleviate the stress generated in the first to sixth downstream beam portions 1161 to 1166 after the joining of the support member 1102 and the head housing unit 1300 and thus prevent breakage of the first to sixth downstream beam portions 1161 to 1166. Accordingly, it is possible to provide a liquid ejection head with high reliability capable of preventing breakage of the first to sixth downstream beam portions 1161 to 1166.

In the third embodiment, the support member 1102 supports the ejection element substrate 1110 in a state where the support member 1102 is joined to the silicon substrate 1150 of the ejection element substrate 1110 with an adhesive. The shape of the silicon substrate 1150 is different from the shape of the support member 1102, and the coefficient of linear expansion of the material of the silicon substrate 1150 is different from the coefficient of linear expansion of the material of the support member 1102. In this way, the stress generated due to the change in temperature from that during the joining of the support member 1102 and the silicon substrate 1150 concentrates at the support member 1102, which has lower strength than the silicon substrate 1150. As described above, the second downstream beam portions 1162, the fourth downstream beam portions 1164, and the sixth downstream beam portions 1166 are arranged to be offset from the first downstream beam portions 1161, the third downstream beam portions 1163, and the fifth downstream beam portions 1165 in the direction along the ejection port arrays. This can alleviate the stress generated in the first to sixth downstream beam portions 1161 to 1166 after the joining of the support member 1102 and the silicon substrate 1150 and thus prevent cracking of the first to sixth downstream beam portions 1161 to 1166. Note that it is desirable to employ the first to sixth downstream beam portions 1161 to 1166 for a liquid ejection head whose ejection port arrays have a length of 0.5 inch or more, as in the first embodiment. Also, the length of each ejection port array may be 12 inches or less, 8 inches or less, or 2 inches or less.

Also, the five second downstream beam portions 1162, the five fourth downstream beam portions 1164, and the five sixth downstream beam portions 1166 may be arranged to be offset from the five first downstream beam portions 1161, the five third downstream beam portions 1163, and the five fifth downstream beam portions 1165 by an equal distance. In other words, the amount of offset between the downstream beam portions in adjacent connection channels among the first to sixth connection channels 1421 to 1426 may be the same for each of the five downstream beam portions provided in the adjacent connection channels. In this way, the channels in the first to sixth connection channels 1421 to 1426 divided by the first to sixth downstream beam portions 1161 to 1166 are unlikely to be uneven. This improves the moldability of the first to sixth connection channels 1421 to 1426. Accordingly, the openings of the first to sixth connection channels 1421 to 1426 can be formed with high accuracy. In this case, the arrangement of the first to sixth downstream beam portions 1161 to 1166 along the direction in which the first to sixth connection channels 1421 to 1426 are arranged side by side (X direction) is desirably a staggered arrangement. The arrangement of the first to sixth downstream beam portions 1161 to 1166 along the direction in which the first to sixth connection channels 1421 to 1426 are arranged side by side may be such an arrangement that they are serially offset in the same direction (e.g., +Y direction).

In the third embodiment, the round downstream corner portions 1171 are formed at the connecting portions between the first to sixth downstream beam portions 1161 to 1166 and the walls of the first to sixth connection channels 1421 to 1426. This can alleviate the stress generated in the first to sixth downstream beam portions 1161 to 1166 and thus prevent breakage of the first to sixth downstream beam portions 1161 to 1166. The radius of curvature of the downstream corner portions 1171 is desirably 0.2 mm or more. The larger the radius of curvature of the downstream corner portions 1171, the greater the extent to which the stress generated in the first to sixth downstream beam portions 1161 to 1166 will be alleviated. For example, in the third embodiment, the radius of curvature of the downstream corner portions 1171 is 0.4 mm. Also, the radius of curvature of the downstream corner portions 1171 may be 8.0 mm or less.

As described above, according to the third embodiment, it is possible to provide a liquid ejection head with high reliability. Specifically, in the present embodiment, in the support member 1102, which is a first channel member, the first to sixth downstream beam portions 1161 to 1166 are formed, which divide the first to sixth connection channels 1421 to 1426 into multiple parallel channels. Moreover, the downstream beam portions in adjacent connection channels among the first to sixth connection channels 1421 to 1426 are arranged to be offset from each other in the direction along the ejection port arrays. This can alleviate the stress generated in the first to sixth downstream beam portions 1161 to 1166 after the joining of the support member 1102 and the head housing unit 1300 and thus prevent breakage of the first to sixth downstream beam portions 1161 to 1166. In this way, a liquid ejection head with high reliability can be provided.

Also, the amount of offset between the downstream beam portions in adjacent connection channels among the first to sixth connection channels 1421 to 1426 is the same for each of the five downstream beam portions provided in the adjacent connection channels. In this way, the channels in the first to sixth connection channels 1421 to 1426 divided by the first to sixth downstream beam portions 1161 to 1166 are unlikely to be uneven. This improves the moldability of the first to sixth connection channels 1421 to 1426. Accordingly, the openings of the first to sixth connection channels 1421 to 1426 can be formed with high accuracy.

Also, the coefficient of linear expansion of the resin material of the support member 1102, which is the first channel member, is lower than the coefficient of linear expansion of the resin material of the head housing unit 1300, which is a second channel member. This reduces the difference between the coefficient of linear expansion of the resin material of the support member 1102 and the coefficient of linear expansion of the material of the ejection element substrate 1110. Accordingly, the stress to be generated in the ejection element substrate 1110 supported on the support member 1102 can be reduced.

Also, the round downstream corner portions 1171 are formed at the connecting portions between the first to sixth downstream beam portions 1161 to 1166 and the walls of the first to sixth connection channels 1421 to 1426. This can alleviate the stress generated in the first to sixth downstream beam portions 1161 to 1166 and thus prevent breakage of the first to sixth downstream beam portions 1161 to 1166.

In the above third embodiment, the second liquid ejection head 1060 has been described, but the liquid ejection head in the third embodiment is not limited to this. The liquid ejection head in the third embodiment may be used as the first liquid ejection head capable of ejecting three types of ink. In this case, the pressure adjustment unit 1200 may include first to third pressure adjustment mechanisms for the three types of ink. In the ejection port forming member 1152 of the ejection element substrate 1110, three ejection port arrays for the three types of ink may be arranged. In the silicon substrate 1150 of the ejection element substrate 1110, the first to third supply paths 1121 to 1123 may be formed. In the head housing unit 1300, the first to third retaining channels 1411 to 1413 forming the first to third liquid channels 1401 to 1403 may be formed. The first to third upstream beam portions 1301 to 1303 may be formed on lower wall portions of the first to third retaining channels 1411 to 1413 in the head housing unit 1300. In the support member 1102, the first to third connection channels 1421 to 1423 forming the first to third liquid channels 1401 to 1403 may be formed. The first to third downstream beam portions 1161 to 1163 may be formed on wall portions of the first to third connection channels 1421 to 1423 in the support member 1102.

### Fourth Embodiment

Next, a fourth embodiment will be described. Some members in the fourth embodiment have similar configurations to those in the above third embodiment. Thus, the description will be given with the same reference signs given to these members as those in the above third embodiment. In the fourth embodiment, a liquid ejection head without ink circulation paths will be described.

### Configuration of Liquid Ejection Head

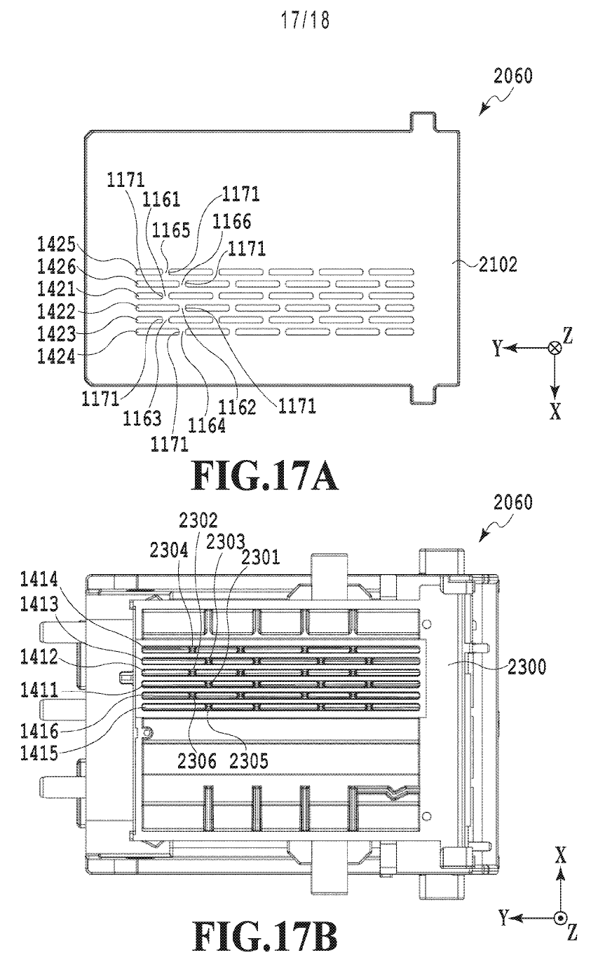

FIGS. 17A and 17B are horizontal cross-sectional views of a second liquid ejection head 2060 in the fourth embodiment. FIG. 17A is a horizontal cross-sectional view illustrating a support member 2102 of the second liquid ejection head 2060. FIG. 17B is a horizontal cross-sectional view illustrating a head housing unit 2300 of the second liquid ejection head 2060. The second liquid ejection head 2060 in the fourth embodiment is formed similarly to the second liquid ejection head 1060 in the third embodiment except for part of the support member 2102 and the head housing unit 2300.

As illustrated in FIG. 17A, the support member 2102 in the fourth embodiment is configured similarly to the support member 1102 in the third embodiment except that the support member 2102 is formed using alumina. The thermal conductivity of alumina is high, and the coefficient of linear expansion of alumina is low. This makes it possible to reduce the stress to be generated in the ejection element substrate 1110 supported by the support member 2102 and make the internal temperature of the ejection element substrate 1110 uniform. Also, the difference between the coefficient of linear expansion of the material of the support member 2102 and the coefficient of linear expansion of the material of the silicon substrate 1150 is small. Accordingly, the stress to be generated by the change in temperature from that during the joining of the support member 2102 and the silicon substrate 1150 can be reduced. In the support member 2102, the first to sixth connection channels 1421 to 1426 and the first to sixth downstream beam portions 1161 to 1166 are formed, as in the third embodiment. The round downstream corner portions 1171 are formed at the connecting portions between the first to sixth downstream beam portions 1161 to 1166 and the walls of the first to sixth connection channels 1421 to 1426.

As illustrated in FIG. 17B, the head housing unit 2300 in the fourth embodiment is configured similarly to the head housing unit 1300 in the third embodiment except for the arrangement of first to sixth upstream beam portions 2301 to 2306. In the head housing unit 2300, the first to sixth retaining channels 1411 to 1416 are formed, as in the third embodiment. The first to sixth upstream beam portions 2301 to 2306 are formed on lower (+Z side) wall portions of the first to sixth retaining channels 1411 to 1416 in the head housing unit 2300 in a different arrangement from that of the first to sixth upstream beam portions 1301 to 1306 in the third embodiment. As mentioned earlier, the support member 2102 is formed using alumina. Thus, the stress generated due to the change in temperature from that during the joining of the support member 2102 and the head housing unit 2300 concentrates at the head housing unit 2300, which has lower strength than the support member 2102.

Here, the second upstream beam portions 2302, the fourth upstream beam portions 2304, and the sixth upstream beam portions 2306 are arranged to be offset from the first upstream beam portions 2301, the third upstream beam portions 2303, and the fifth upstream beam portions 2305 in the direction along the ejection port arrays (Y direction). In other words, the upstream beam portions in adjacent retaining channels among the first to sixth retaining channels 1411 to 1416 are arranged to be offset from each other in the direction along the ejection port arrays. This can alleviate the stress generated in the first to sixth upstream beam portions 2301 to 2306 after the joining of the support member 2102 and the head housing unit 2300 and thus prevent breakage of the first to sixth upstream beam portions 2301 to 2306. Accordingly, it is possible to provide a liquid ejection head with high reliability capable of preventing breakage of its first to sixth upstream beam portions 2301 to 2306.

Also, the four second upstream beam portions 2302, the four fourth upstream beam portions 2304, and the four sixth upstream beam portions 2306 may be arranged to be offset from the four first upstream beam portions 2301, the four third upstream beam portions 2303, and the four fifth upstream beam portions 2305 by an equal distance. In other words, the amount of offset between the upstream beam portions in adjacent retaining channels among the first to sixth retaining channels 1411 to 1416 may be the same for each of the four upstream beam portions provided in the adjacent retaining channels. In this way, the channels in the first to sixth retaining channels 1411 to 1416 divided by the first to sixth upstream beam portions 2301 to 2306 are unlikely to be uneven. This improves the moldability of the first to sixth retaining channels 1411 to 1416. Accordingly, the lower (+Z side) openings of the first to sixth retaining channels 1411 to 1416 can be formed with high accuracy. In this case, the arrangement of the first to sixth upstream beam portions 2301 to 2306 along the direction in which the first to sixth retaining channels 1411 to 1416 are arranged side by side (X direction) is desirably a staggered arrangement. The arrangement of the first to sixth upstream beam portions 2301 to 2306 along the direction in which the first to sixth retaining channels 1411 to 1416 are arranged side by side may be such an arrangement that they are serially offset in the same direction (e.g., +Y direction).

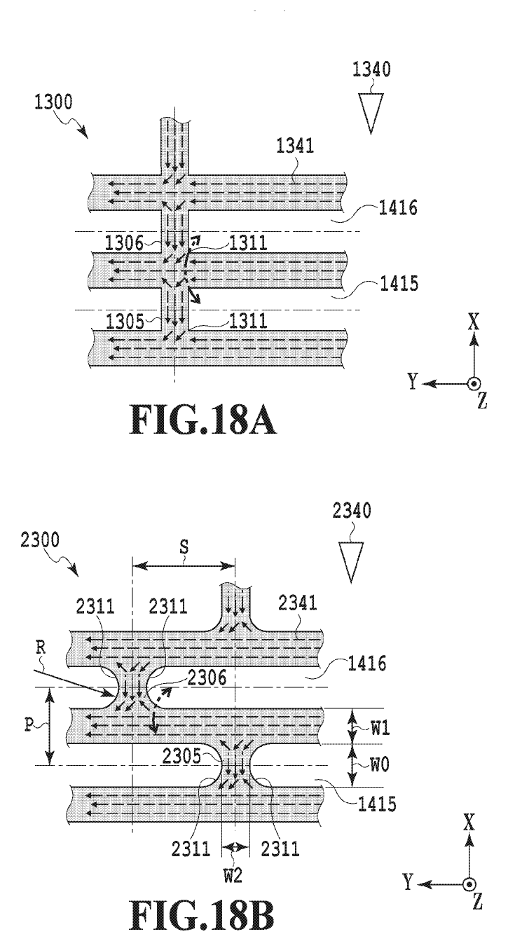

Also, round upstream corner portions 2311 (see FIG. 18B) are formed at the connecting portions between the first to sixth upstream beam portions 2301 to 2306 and the walls of the first to sixth retaining channels 1411 to 1416. This can alleviate the stress generated in the first to sixth upstream beam portions 2301 to 2306 and thus prevent breakage of the first to sixth upstream beam portions 2301 to 2306. A radius of curvature R of the upstream corner portions 2311 is desirably 0.2 mm or more. Also, the radius of curvature R of the upstream corner portions 2311 may be 8.0 mm or less.

Also, as in the third embodiment, the first to sixth downstream beam portion 1161 to 1166 may be arranged to be situated on both sides of extension lines extending from the first to sixth upstream beam portions 2301 to 2306 to the first to sixth connection channels 1421 to 1426. In this way, the difference in flow velocity is small between the ink flows through the channels on the lower sides of the first to sixth retaining channels 1411 to 1416 divided by the first to sixth upstream beam portions 1301 to 1306. Accordingly, fine bubbles included in the inks flowing through the first to sixth retaining channels 1411 to 1416 will spread into the channels on the lower sides of the first to sixth retaining channels 1411 to 1416 and will not aggregate at certain positions. As described above, fine bubbles included in the inks flowing through the first to sixth retaining channels 1411 to 1416 are spread. This can prevent a deterioration in print quality. Accordingly, it is possible to provide a liquid ejection head with high robustness against bubbles formed inside the liquid ejection head.

### Chemical Cracking

Next, chemical cracking that can occur in the liquid ejection head will be described. The liquid ejection head in the fourth embodiment (second liquid ejection head 2060) can be used for various applications. The liquids to be ejected from the liquid ejection head in the fourth embodiment contain various chemical substances, such as various organic solvents, inorganic acids, inorganic alkalis, ionic liquids, metal ions, surfactants, oils, and water-soluble resins, for example. It is known that contact between a stressed portion of a molded resin product and a chemical substance cause cracks in the molded resin product due to a phenomenon referred to as "chemical cracking." Chemical cracking is a phenomenon in which the chemical substance permeates through the stressed portion of the molded resin product and interacts with the stress, thereby causing cracks. Chemical cracking is referred to also as solvent cracking. The liquid ejection head in the fourth embodiment is required to be compatible with a variety of chemical substances and thus needs to reduce the occurrence of chemical cracking. In fourth embodiment, the head housing unit 2300 is formed by injection molding using a resin material to which a filler is added. The filler added to the resin material includes at least one of acicular particles or tabular particles. Thus, the orientation of the filler is determined by the shapes, arrangements, and the like of the walls of the first to sixth retaining channels 1411 to 1416 and the first to sixth upstream beam portions 2301 to 2306. In the present embodiment, the orientation of the filler represents the direction of the acicular particles or tabular particles forming the filler in the molded resin product (head housing unit).

FIGS. 18A and 18B are schematic diagrams illustrating the orientations of fillers in the vicinity of upstream beam portions in head housing units. FIG. 18A is a schematic diagram illustrating the orientation of a filler 1341 in the vicinity of upstream beam portions in the head housing unit 1300 in the third embodiment. FIG. 18B is a schematic diagram illustrating the orientation of a filler 2341 in the vicinity of upstream beam portions in the head housing unit 2300 in the fourth embodiment. In the injection molding of the head housing unit, the resin material, which is a thermoplastic resin, is filled into the mold from a gate. The resin material filled in the mold flows away from the gate along the shape of the head housing unit. In a case where the orientation of the filler containing acicular particles or tabular particles is aligned in the flow direction of the resin material, the effect of the filler will be lower than otherwise. Accordingly, the strength of the head housing unit in the direction along the orientation of the filler will be lower than its strength in directions orthogonal to the orientation of the filler. Meanwhile, the filler containing tabular particles has the effect of blocking penetration of gases, water vapor, and the like in directions orthogonal to the orientation of the filler.

As illustrated in FIG. 18A, in the injection molding of the head housing unit 1300 in the third embodiment, the resin material filled in the mold flows away from a gate 1340 along the shape of the head housing unit 1300. In the case where the first to sixth upstream beam portions 1301 to 1306 are arranged at the same positions in the Y direction, the orientation of the filler 1341 at the connecting portions between each upstream beam portion and the walls of the corresponding retaining channel may be substantially the same as the direction of cracking that may occur at the connecting portions. Accordingly, cracks can be easily formed by the phenomenon referred to as chemical cracking at the connecting portions between each upstream beam portion and the walls of the corresponding retaining channel. Note that the directions of the cracks that may be formed at the connecting portions between each upstream beam portion and the walls of the corresponding retaining channel are the directions of the double-dash chain line arrow illustrated in FIG. 18A. In FIG. 18A, cracking portions 1311 where a crack can be easily formed are indicated at the connecting portion between the fifth upstream beam portion 1305 and a wall of the fifth retaining channel 1415 and the connection portion between the sixth upstream beam portion 1306 and a wall of the sixth retaining channel 1416.

As illustrated in FIG. 18B, in the injection molding of the head housing unit 2300 in the fourth embodiment, the resin material filled in the mold flows away from a gate 2340 along the shape of the head housing unit 2300. The second upstream beam portions 2302, the fourth upstream beam portions 2304, and the sixth upstream beam portions 2306 are arranged to be offset from the first upstream beam portions 2301, the third upstream beam portions 2303, and the fifth upstream beam portions 2305 in the direction along the ejection port arrays (Y direction). For example, in the sixth retaining channel 1416 adjacent to the fifth retaining channel 1415 (and the first retaining channel 1411), the sixth upstream beam portions 2306 are not arranged at the same positions in the Y direction as the fifth upstream beam portions 2305 (and the first upstream beam portions 2301). Also, the round upstream corner portions 2311 are formed at the connecting portions between the first to sixth upstream beam portions 2301 to 2306 and the walls of the first to sixth retaining channels 1411 to 1416. Note that FIG. 18B illustrates the upstream side corner portions 2311 formed at the connecting portions between a fifth upstream beam portion 2305 and the walls of the fifth retaining channel 1415 and the connecting portions between a sixth upstream beam portion 2306 and the walls of the sixth retaining channel 1416. In this way, the orientation of the filler 2341 at the connecting portions between each upstream beam portion and the walls of the corresponding retaining channel is orthogonal to the directions of cracks that may be formed at the connecting portions (the directions of the double-dash chain line arrow illustrated in FIG. 18B). This can improve the strength of each upstream beam portion against cracking and reduce the amount of permeation of the chemical substance into each upstream beam portion. Accordingly, the occurrence of chemical cracking can be reduced.

As illustrated in FIG. 18B, the channel width of the first to sixth retaining channels 1411 to 1416 forming the first to sixth liquid channels 1401 to 1406 in the traverse direction (the channel width in the X direction) is defined as W0. The thickness of the wall between adjacent retaining channels among the first to sixth retaining channels 1411 to 1416 (the thickness in the X direction) is defined as W1. The thickness of the first to sixth upstream beam portions 2301 to 2306 (the thickness in the Y direction) is defined as W2. The center-to-center distance between adjacent retaining channels among the first to sixth retaining channels 1411 to 1416 is defined as P. The amount of offset between the upstream beam portions in adjacent retaining channels among the first to sixth retaining channels 1411 to 1416 is defined as S.

The larger the thickness W1 of the wall between adjacent retaining channels, the greater the extent to which the strength of the upstream beam portions against cracking is improved. The smaller the pitch at which the multiple ejection port arrays are arranged side by side, the smaller the thickness W1 of the wall between adjacent retaining channels and therefore the higher the likelihood of chemical cracking.

In a case where the length of the ejection port arrays is more than 1 inch, the thickness W1 of the wall between adjacent retaining channels is desirably more than 1.7 mm to ensure the strength of the head housing unit 2300. Also, the channel width W0 of the first to sixth retaining channels 1411 to 1416 in the traverse direction is desirably 1.5 mm or more to ensure the strength of the mold. The center-to-center distance P between adjacent retaining channels is desirably more than 3.2 mm. However, the center-to-center distance P between adjacent retaining channels is often 3.2 mm or less in order to reduce the manufacturing costs of the ejection element substrate 1110. In the present embodiment, the center-to-center distance P between adjacent retaining channels is 1.9 mm, and the thickness W1 of the wall between adjacent retaining channels is 0.9 mm. Thus, the center-to-center distance P between adjacent retaining channels may be 3.2 mm or less. Also, for manufacturing reasons, the center-to-center distance P between adjacent retaining channels may be 0.5 mm or more.

The thickness W2 of the first to sixth upstream beam portions 2301 to 2306 is desirably less than or equal to twice the thickness W1 of the wall between adjacent retaining channels to avoid deteriorations in processing accuracy due to sink marks and the like. In the present embodiment, the thickness W2 of the first to sixth upstream beam portions 2301 to 2306 is 1.0 mm, and the thickness W1 of the wall between adjacent retaining channels is 0.9 mm. Thus, the thickness W2 of the first to sixth upstream beam portions 2301 to 2306 is less than or equal to twice the thickness W1 of the wall between adjacent retaining channels.

Now, a case where the relationship between the channel width W0 of the first to sixth retaining channels 1411 to 1416 in the traverse direction and the thickness W1 of the wall between adjacent retaining channels is represented by Inequality (1) below will be described. W0 ≥ W1 … (1)

In this case, the relationship between an amount of offset S between the upstream beam portions in adjacent retaining channels and the center-to-center distance P between adjacent retaining channels is desirably represented by Inequality (2) below. S ≥ P … (2)

In the present embodiment, the condition of Inequality (2) is satisfied since the amount of offset S between the upstream beam portions in adjacent retaining channels is 2.5 mm, and the center-to-center distance P between adjacent retaining channels is 1.9 mm. Also, the condition of Inequality (1) is satisfied in a case where the channel width W0 of the first to sixth retaining channels 1411 to 1416 in the traverse direction is 0.9 mm or more. Satisfying the conditions of Inequality (1) and Inequality (2) makes it possible to increase the amount of the filler at the connecting portions between each upstream beam portion and the walls of the corresponding retaining channel that is oriented to be orthogonal to the directions of cracks which may be formed at the connecting portions. Note that the center-to-center distance P between adjacent retaining channels may be referred to as the "opening pitch" between adjacent retaining channels or "inter-color pitch."

Next, a case where the relationship between the channel width W0 of the first to sixth retaining channels 1411 to 1416 in the traverse direction and the thickness W1 of the wall between adjacent retaining channels is represented by Inequality (3) below will be described. W0 < W1 … (3)

In this case, the relationship between the amount of offset S between the upstream beam portions in adjacent retaining channels and the center-to-center distance P between adjacent retaining channels is desirably represented by Inequality (4) below. S ≥ P × (W2/W1) … (4)

As mentioned earlier, the amount of offset S between the upstream beam portions in adjacent retaining channels is 2.5 mm, and the center-to-center distance P between adjacent retaining channels is 1.9 mm. Moreover, the thickness W2 of the first to sixth upstream beam portions 2301 to 2306 is 1.0 mm, and the thickness W1 of the wall between adjacent retaining channels is 0.9 mm. Hence, the condition of Inequality (4) is satisfied. Also, the condition of Inequality (3) is satisfied in a case where the channel width W0 of the first to sixth retaining channels 1411 to 1416 in the traverse direction is less than 0.9 mm. Satisfying the conditions of Inequality (3) and Inequality (4) makes it possible to increase the amount of the filler at the connecting portions between each upstream beam portion and the walls of the corresponding retaining channel that is oriented to be orthogonal to the directions of cracks which may be formed at the connecting portions.

As described above, according to the fourth embodiment, it is possible to provide a liquid ejection head with high reliability. Specifically, in the present embodiment, in the head housing unit 2300, which is a first channel member, the first to sixth upstream beam portions 2301 to 2306 are formed, which divide the first to sixth retaining channels 1411 to 1416 into multiple parallel channels. Moreover, the upstream beam portions in adjacent retaining channels among the first to sixth retaining channels 1411 to 1416 are arranged to be offset from each other in the direction along the ejection port arrays. This can alleviate the stress generated in the first to sixth upstream beam portions 2301 to 2306 after the joining of the support member 2102 and the head housing unit 2300 and thus prevent breakage of the first to sixth upstream beam portions 2301 to 2306. In this way, a liquid ejection head with high reliability can be provided.

Also, the amount of offset between the upstream beam portions in adjacent retaining channels among the first to sixth retaining channels 1411 to 1416 is the same for each of the four upstream beam portions provided in the adjacent retaining channels. In this way, the channels in the first to sixth retaining channels 1411 to 1416 divided by the first to sixth upstream beam portions 2301 to 2306 are unlikely to be uneven. This improves the moldability of the first to sixth retaining channels 1411 to 1416. Accordingly, the lower openings of the first to sixth retaining channels 1411 to 1416 can be formed with high accuracy.

Also, the support member 2102, which is a second channel member, is formed using alumina. This makes it possible to reduce the stress to be generated in the ejection element substrate 1110 supported by the support member 2102 and make the internal temperature of the ejection element substrate 1110 uniform, as in the first embodiment.

Also, the round upstream corner portions 2311 are formed at the connecting portions between the first to sixth upstream beam portions 2301 to 2306 and the walls of the first to sixth retaining channels 1411 to 1416. This can alleviate the stress generated in the first to sixth upstream beam portions 2301 to 2306 and thus prevent breakage of the first to sixth upstream beam portions 2301 to 2306.

In the above fourth embodiment, the second liquid ejection head 2060 has been described, but the liquid ejection head in the fourth embodiment is not limited to this. The liquid ejection head in the fourth embodiment may be used as the first liquid ejection head capable of ejecting three types of ink. In this case, the first to third retaining channel 1411 to 1413 may be formed in the head housing unit 2300, as has been described in the third embodiment. The first to third upstream beam portions 2301 to 2303 may be formed on lower wall portions of the first to third retaining channels 1411 to 1413 in the head housing unit 2300. In the support member 2102, the first to third connection channels 1421 to 1423 may be formed. The first to third downstream beam portions 1161 to 1163 may be formed on wall portions of the first to third connection channels 1421 to 1423 in the support member 2102.

In the above fourth embodiment, the round upstream corner portions 2311 are formed at the connecting portions between the first to sixth upstream beam portions 2301 to 2306 and the walls of the first to sixth retaining channels 1411 to 1416, but the configuration is not limited to this. For example, round corner portions may be formed at the connecting portions between the supply-side beam portions 301 and the walls of the supply-side retaining channels 411 in the first embodiment, and round corner portions may be formed at the connecting portions between the collection-side beam portions 302 and the walls of the collection-side retaining channels 412. The radius of curvature of the corner portions on the supply-side beam portions 301 and the collection-side beam portions 302 may be 0.2 mm or more and may be 8.0 mm or less.

Also, round corner portions may be formed at the connecting portions between the first to sixth supply-side beam portions 801A to 801F and the walls of the first to sixth supply-side retaining channels 911A to 911F in the second embodiment. Round corner portions may be formed at the connecting portions between the first and second collection-side beam portions 802A and 802B and the walls of the first and second collection-side retaining channels 912A and 912B. Round corner portions may be formed at the connecting portions between the fourth and fifth collection-side beam portions 802D and 802E and the walls of the fourth and fifth collection-side retaining channels 912D and 912E. The radius of curvature of the corner portions at the first to sixth supply-side beam portions 801A to 801F may be 0.2 mm or more and may be 8.0 mm or less. The radius of curvature of the corner portions at the first and second collection-side beam portions 802A and 802B and the fourth and fifth collection-side beam portions 802D and 802E may be 0.2 mm or more and may be 8.0 mm or less.

In the above fourth embodiment, the upstream beam portions in adjacent retaining channels among the first to sixth retaining channels 1411 to 1416 are arranged to be offset from each other in the direction along the ejection port arrays, but the configuration is not limited to this. For example, the upstream beam portions in adjacent retaining channels among the first to sixth retaining channels 1411 to 1416 may be arranged to be offset from each other in the direction in which the ejection ports 1115 extend (Z direction).

In the above first, second, and fourth embodiments, the support member are formed using alumina, but the material of the support member is not limited to this. Also, the head housing unit is formed using a resin material to which a filler is added, but the material of the head housing unit is not limited to this. For example, the support member may be formed using silicon. The head housing unit may be formed using a resin material to which no filler is added (e.g., polyethylene). The coefficient of linear expansion of silicon is approximately 3 ppm/°C. The coefficient of linear expansion of polyethylene to which no filler is added is approximately 150 ppm/°C. In this case, the difference between the coefficient of linear expansion of the material of the head housing unit and the coefficient of linear expansion of the material of the support member is approximately 147 ppm/°C. Thus, the difference (absolute value) between the coefficient of linear expansion of the material of the head housing unit and the coefficient of linear expansion of the material of the support member may be 147 ppm/°C or less.

In each of the above embodiments, the first liquid ejection head and the second liquid ejection head are so-called serial liquid ejection heads which eject liquids, such as inks, while moving in the main scanning direction, but the liquid ejection heads are not limited to these. The first liquid ejection head and the second liquid ejection head may be so-called full-line liquid ejection heads which are capable of ejecting liquids over the entire print medium MD in its width direction without moving in the main scanning direction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a liquid ejection head with high reliability.

This application claims the benefit of Japanese Patent Application No. 2024-187423, filed October 24, 2024, which is hereby incorporated by reference herein in its entirety.

What is claimed is:

1. A liquid ejection head comprising:
an ejection element substrate having a plurality of ejection port arrays each being a plurality of ejection ports for ejecting a liquid arranged in a line; and
a first channel member and a second channel member forming a plurality of liquid channels communicating the plurality of ejection port arrays, wherein
the first channel member or the second channel member supports the ejection element substrate,
the first channel member is formed using a resin material, is joined to the second channel member, and has a beam portion dividing part of the liquid channels into a plurality of parallel channels, and
the beam portions in adjacent liquid channels among the plurality of liquid channels are arranged to be offset from each other.

2. The liquid ejection head according to claim 1, wherein the beam portions in the adjacent liquid channels are arranged to be offset from each other in a direction along the ejection port arrays.

3. The liquid ejection head according to claim 2, wherein
the first channel member has a plurality of beam portions arranged side by side in the direction along the ejection port arrays in the liquid channels, and
an amount of the offset between the beam portions in the adjacent liquid channels is the same for each of the plurality of beam portions.

4. The liquid ejection head according to claim 2, wherein an arrangement of the beam portions along a direction in which the plurality of liquid channels are arranged side by side is a staggered arrangement.

5. The liquid ejection head according to claim 1, wherein a coefficient of linear expansion of a material of the first channel member is different from a coefficient of linear expansion of a material of the second channel member.

6. The liquid ejection head according to claim 5, wherein a difference between the coefficient of linear expansion of the material of the first channel member and the coefficient of linear expansion of the material of the second channel member is 6 ppm/°C or more.

7. The liquid ejection head according to claim 1, wherein a round corner portion is formed at a connecting portion between the beam portion and a wall of each of the liquid channels.

8. The liquid ejection head according to claim 7, wherein a radius of curvature of the corner portion is 0.2 mm or more.

9. The liquid ejection head according to claim 1, wherein the second channel member supports the ejection element substrate.

10. The liquid ejection head according to claim 9, wherein the second channel member is formed using alumina.

11. The liquid ejection head according to claim 9, wherein
the beam portions in the adjacent liquid channels are arranged to be offset from each other in a direction along the ejection port arrays,
a relationship between a channel width of the liquid channels in a traverse direction and a thickness of a wall between the adjacent liquid channels is represented by the following inequality
W0 ≥ W1
where W0 is the channel width of the liquid channels in the traverse direction, and W1 is the thickness of the wall between the adjacent liquid channels, and
a relationship between an amount of the offset between the beam portions in the adjacent liquid channels and a center-to-center distance between the adjacent liquid channels is represented by the following inequality
S ≥ P
where S is the amount of the offset between the beam portions in the adjacent liquid channels, and P is the center-to-center distance between the adjacent liquid channels.

12. The liquid ejection head according to claim 9, wherein
the beam portions in the adjacent liquid channels are arranged to be offset from each other in a direction along the ejection port arrays,
a relationship between a channel width of the liquid channels in a traverse direction and a thickness of a wall between the adjacent liquid channels is represented by the following inequality
W0 < W1
where W0 is the channel width of the liquid channels in the traverse direction, and W1 is the thickness of the wall between the adjacent liquid channels, and
a relationship between an amount of the offset between the beam portions in the adjacent liquid channels and a center-to-center distance between the adjacent liquid channels is represented by the following inequality
S ≥ P × (W2/W1)
where S is the amount of the offset between the beam portions in the adjacent liquid channels, P is the center-to-center distance between the adjacent liquid channels, and W2 is a thickness of the beam portion.

13. The liquid ejection head according to claim 9, wherein
the first channel member forms upstream sides of the liquid channels, and the second channel member forms downstream sides of the liquid channels,
the part of the liquid channels is the upstream sides of the liquid channels,
the second channel member has a downstream beam portion dividing the downstream sides of the liquid channels into a plurality of parallel channels,
the first channel member has a plurality of beam portions arranged side by side in the direction along the ejection port arrays on the upstream sides of the liquid channels,
the second channel member has a plurality of downstream beam portions arranged side by side in the direction along the ejection port arrays on the downstream sides of the liquid channels, and
the plurality of downstream beam portions are arranged to be situated on both sides of extension lines extending from the plurality of beam portions to the downstream sides of the liquid channels.

14. The liquid ejection head according to claim 9, wherein the beam portion is not arranged in one or more liquid channels among the plurality of liquid channels.

15. The liquid ejection head according to claim 9, wherein
the first channel member has a plurality of beam portions arranged side by side in the direction along the ejection port arrays in the liquid channels, and
the number of the beam portions in one or more liquid channels among the plurality of liquid channels is smaller than the number of the beam portions in the other liquid channel or channels excluding the one or more liquid channels.

16. The liquid ejection head according to claim 1, wherein the first channel member supports the ejection element substrate.

17. The liquid ejection head according to claim 16, wherein
the second channel member is formed using a resin material, and
a coefficient of linear expansion of a material of the first channel member is lower than a coefficient of linear expansion of the material of the second channel member.

18. The liquid ejection head according to claim 16, wherein
the first channel member forms downstream sides of the liquid channels, and the second channel member forms upstream sides of the liquid channels,
the part of the liquid channels is the downstream sides of the liquid channels,
the second channel member has an upstream beam portion dividing the upstream sides of the liquid channels into a plurality of parallel channels,
the first channel member has a plurality of beam portions arranged side by side in the direction along the ejection port arrays on the downstream sides of the liquid channels,
the second channel member has a plurality of upstream beam portions arranged side by side in the direction along the ejection port arrays on the upstream sides of the liquid channels, and
the plurality of beam portions are arranged to be situated on both sides of extension lines extending from the plurality of upstream beam portions to the downstream sides of the liquid channels.

19. A liquid ejection apparatus comprising a liquid ejection head including
an ejection element substrate having a plurality of ejection port arrays each being a plurality of ejection ports for ejecting a liquid arranged in a line, and
a first channel member and a second channel member forming a plurality of liquid channels communicating the plurality of ejection port arrays, wherein
the first channel member or the second channel member supports the ejection element substrate,
the first channel member is formed using a resin material, is joined to the second channel member, and has a beam portion dividing part of the liquid channels into a plurality of parallel channels, and
the beam portions in adjacent liquid channels among the plurality of liquid channels are arranged to be offset from each other.

20. The liquid ejection apparatus according to claim 19, wherein
the liquid ejection apparatus comprises a plurality of liquid ejection heads, and
the liquid ejection apparatus further comprises a carriage carrying the plurality of liquid ejection heads, wherein
one or more liquid ejection heads among the plurality of liquid ejection heads eject a reaction liquid that reacts with the liquid ejected from the other liquid ejection head or heads excluding the one or more liquid ejection heads.
